(19) United States
(12) Patent Application Publication
(10) Pub. No.: US 2025/0247600 A1
(43) Pub. Date: Jul. 31, 2025

(54) CONTROL APPARATUS, CONTROL METHOD OF CONTROL APPARATUS, AND STORAGE MEDIUM

(71) Applicant: CANON KABUSHIKI KAISHA, Tokyo (JP)

(72) Inventors: SEIGO KANEKO, Kanagawa (JP); KENTARO FUKUNAGA, Kanagawa (JP)

(21) Appl. No.: 19/035,661

(22) Filed: Jan. 23, 2025

(30) Foreign Application Priority Data
Jan. 29, 2024 (JP) 2024-011178

(51) Int. Cl. H04N 23/61; G06F 3/14; G06T 7/20; G09G 5/377; H04N 23/63; H04N 23/69; H04N 23/695

(52) U.S. Cl. CPC H04N 23/61; G06F 3/14; G06T 7/20; G09G 5/377; H04N 23/632; H04N 23/69; H04N 23/695

(57) ABSTRACT

A control apparatus includes one or more memories storing a program and one or more processors executing the program to acquire a detection result of an object detected from images acquired by a plurality of respective imaging units configured to move independently on a same circumference, control display of an image in which the object is detected and the image of an imaging unit adjacent to an imaging unit acquiring the image in which the object is detected on a display unit, and superimpose an image related to the object on the image of the adjacent imaging unit.

### BACKGROUND

### Field

The present disclosure relates to a control apparatus, a control method of the control apparatus, and a storage medium.

### Description of the Related Art

To enable imaging in a plurality of directions with a single camera, there is a camera that includes a plurality of imaging units (hereinafter, multi-lens camera). Among multi-lens cameras is an imaging apparatus including a driving mechanism that independently drives imaging units on a common driving axis, like along the same circumference. A display device of an imaging system including such an imaging apparatus tiles images captured by the respective imaging units (Japanese Patent Application Laid-Open No. 2021-148984). An imaging apparatus having a function of detecting an object such as a moving body has also conventionally been known.

When a moving body is detected by one of the imaging units, the display provided by the display device discussed in Japanese Patent Application Laid-Open No. 2021-148984 is difficult to understand the relationship between the moving body and the imaging units other than the one detecting the moving body from.

### SUMMARY

The present disclosure is directed to enabling easy understanding of a relationship between an image in which an object is detected and other images.

According to an aspect of the present disclosure, a control apparatus includes one or more memories storing a program and one or more processors executing the program to acquire a detection result of an object detected from images acquired by a plurality of respective imaging units configured to move independently on a same circumference, control display of an image in which the object is detected and an image of an imaging unit adjacent to an imaging unit acquiring the image in which the object is detected on a display unit, and control superimposing an image related to the object on the image of the adjacent imaging unit.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of an imaging system.

FIG. 2 is a diagram illustrating an imaging apparatus.

FIG. 3 is a side view of the imaging apparatus.

FIG. 4 is a flowchart illustrating object detection.

FIGS. 5A and 5B are diagrams illustrating a display example of on-screen displays (OSDs).

FIG. 6 is a diagram illustrating imaging regions.

FIG. 7 is a diagram illustrating the imaging regions after pan/tilt driving.

FIGS. 8A and 8B are diagrams illustrating examples of OSDs.

FIGS. 9A to 9F are diagrams illustrating examples of complementary imaging.

FIGS. 10A and 10B are diagrams illustrating a driving range.

FIGS. 11A and 11B are diagrams illustrating a display example where the images are each shifted by one.

FIGS. 12A and 12B are diagrams illustrating a display example where the images are switched in position.

FIGS. 13A and 13B are diagrams illustrating a display example where the images of adjacent cameras are arranged on both sides of the image of an object-detecting camera.

FIGS. 14A and 14B are diagrams illustrating a display and arrangement example for imaging in portrait orientation.

FIGS. 15A and 15B are diagrams illustrating a display example of a rearrangement method and a method for driving adjacent cameras.

FIG. 16 is a flowchart illustrating rearranging images.

FIGS. 17A and 17B are diagrams illustrating an example where an object has moved.

FIG. 18 is a diagram illustrating a configuration example of the imaging system.

FIG. 19 is a diagram illustrating a configuration example of the imaging system.

FIGS. 20A and 20B are flowcharts illustrating object detection.

### DESCRIPTION OF THE EMBODIMENTS

Exemplary embodiments of the present disclosure will be described in detail below with reference to the drawings. The following exemplary embodiments are not intended to limit the scope of the claims. While the exemplary embodiments describe a plurality of features, all the plurality of features is not necessarily essential, and the features can be freely combined. In the diagrams, the same or similar components are denoted by the same reference numerals. A redundant description thereof will be omitted.

### Imaging System

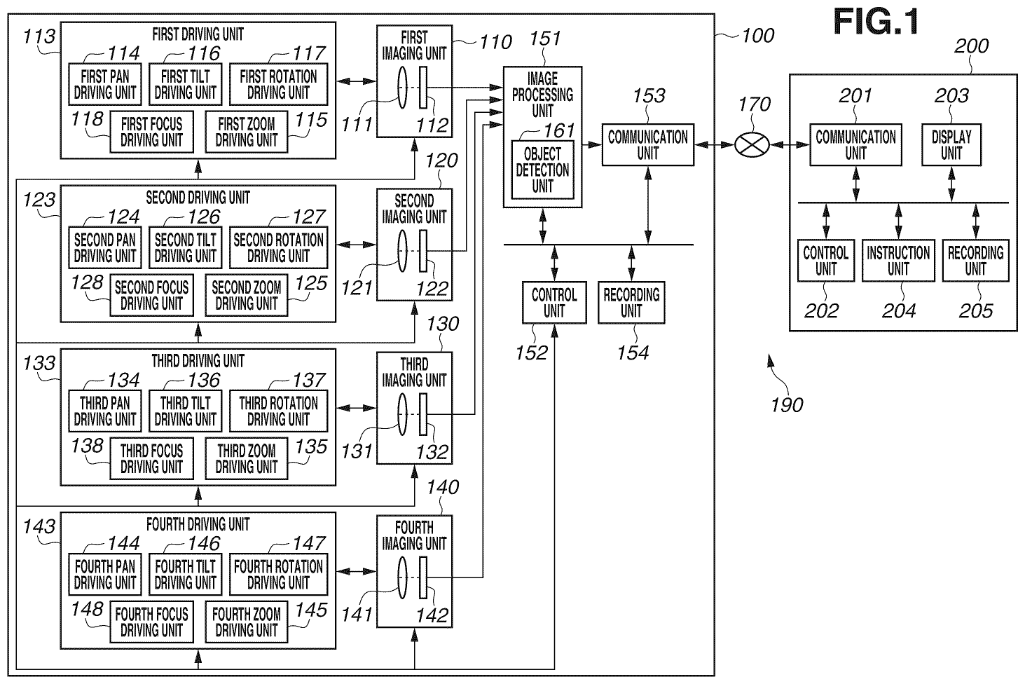

A configuration of an imaging system 190 according to a first exemplary embodiment will be described below with reference to FIG. 1. The imaging system 190 includes an imaging apparatus 100 and a client apparatus 200.

The imaging apparatus 100 includes four imaging units 110, 120, 130, and 140, independent driving units 113, 123, 133, and 143 for the respective imaging units 110, 120, 130, and 140, an image processing unit 151, a control unit 152, a communication unit 153, and a recording unit 154.

The imaging apparatus 100 includes a first imaging unit 110, a second imaging unit 120, a third imaging unit 130, and a fourth imaging unit 140. The imaging apparatus 100 also includes a first driving unit 113, a second driving unit 123, a third driving unit 133, and a fourth driving unit 143.

In the imaging system 190, the imaging apparatus 100 is connected to the client apparatus 200 via a network 170, and can transmit image data captured by the imaging apparatus 100 and receive control signals for the imaging apparatus 100.

### Imaging Units

The first imaging unit 110 includes an imaging optical system 111 and a solid-state image sensor 112. The second imaging unit 120 includes an imaging optical system 121 and a solid-state image sensor 122. The third imaging unit 130 includes an imaging optical system 131 and a solid-state image sensor 132. The fourth imaging unit 140 includes an imaging optical system 141 and a solid-state image sensor 142.

Light transmitted through the imaging optical systems 111, 121, 131, and 141 is focused on the solid-state image sensors 112, 122, 132, and 142, respectively, and converted into electrical signals. The electrical signals are output as image data through processing by the image processing unit 151. The control unit 152 controls the driving and signal reading of each of the solid-state image sensors 112, 122, 132, and 142.

The first driving unit 113 includes a first pan driving unit 114, a first zoom driving unit 115, a first tilt driving unit 116, a first rotation driving unit 117, and a first focus driving unit 118.

The second driving unit 123 includes a second pan driving unit 124, a second zoom driving unit 125, a second tilt driving unit 126, a second rotation driving unit 127, and a second focus driving unit 128.

The third driving unit 133 includes a third pan driving unit 134, a third zoom driving unit 135, a third tilt driving unit 136, a third rotation driving unit 137, and a third focus driving unit 138.

The fourth driving unit 143 includes a fourth pan driving unit 144, a fourth zoom driving unit 145, a fourth tilt driving unit 146, a fourth rotation driving unit 147, and a fourth focus driving unit 148.

The imaging units 110, 120, 130, and 140 include respective zoom lenses that the imaging optical systems 111, 121, 131, and 141 can drive in their optical axis directions. The control unit 152 can control the imaging ranges of the imaging units 110, 120, 130, and 140 by controlling the first, second, third, and fourth zoom driving units 115, 125, 135, and 145.

The imaging units 110, 120, 130, and 140 include respective focus lenses that the imaging optical systems 111, 121, 131, and 141 can drive in their optical axis directions. The control unit 152 can control the focuses of the imaging units 110, 120, 130, and 140 by controlling the first, second, third, and fourth focus driving units 118, 128, 138, and 148.

The driving units 113, 123, 133, and 143 include the rotation driving units 117, 127, 137, and 147, respectively, that can drive the solid-state image sensors 112, 122, 132, and 142 to rotate about rotation axes in the respective optical axis directions. The control unit 152 can control the imaging angles of the imaging units 110, 120, 130, and 140 by controlling the first, second, third, and fourth rotation driving units 117, 127, 137, and 147.

### Pan/Tilt Driving Units

The driving units 113, 123, 133, and 143 include the pan driving units 114, 124, 134, and 144, and the tilt driving units 116, 126, 136, and 146. The pan driving units 114, 124, 134, and 144, and the tilt driving units 116, 126, 136, and 146 are driving units for changing the imaging directions.

The first, second, third, and fourth driving units 113, 123, 133, and 143 include the first, second, third, and fourth pan driving units 114, 124, 134, and 144, respectively. Similarly, the first, second, third, and fourth driving units 113, 123, 133, and 143 include the first, second, third, and fourth tilt driving units 116, 126, 136, and 146, respectively.

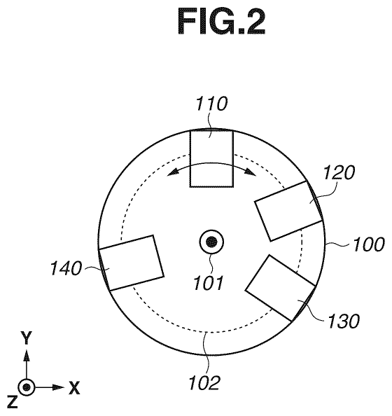

The first, second, third, and fourth pan driving units 114, 124, 134, and 144 are configured to have the same rotation axis so that the imaging units 110, 120, 130, and 140 are located on the same circumference and rotate on the same circumference. A specific description will be given with reference to FIG. 2.

FIG. 2 is a diagram illustrating the imaging apparatus 100 according to the first exemplary embodiment. To simplify the following description, content that is redundant between the imaging units (first, second, third, and fourth imaging units 110, 120, 130, and 140) will be described by using the first imaging unit 110 in a representative manner, and a description of the other imaging units will be omitted. Similarly, for the driving units 113, 123, 133, and 143, the first driving unit 113 will be described in a representative manner, and a description of the other driving units will be omitted. Differences between the imaging units will be explicitly stated, if any.

FIG. 2 is a structure diagram of the imaging apparatus 100 seen from above (from a +Z-axis side). The pan driving units 114, 124, 134, and 144 include a motor and a gear each, and drive the respective imaging units 110, 120, 130, and 140 by controlling power to drive the motors.

The pan driving units 114, 124, 134, and 144 are configured to be rotatable with a shaft 101 as the rotation axis. A circumference 102 represents the common circumference along which the imaging units 110, 120, 130, and 140 can be driven with the shaft 101 as the rotation axis. The power to drive the motors is controlled by the control unit 152.

The imaging apparatus 100 can independently drive the imaging units 110, 120, 130, and 140, and can independently drive one or more of the pan driving units 114, 124, 134, and 144 at the same time. Since all the imaging units 110, 120, 130, and 140 are driven on the same circumference 102, the imaging units 110, 120, 130, and 140 do not switch positions. The plurality of imaging units 110, 120, 130, and 140 is located on the same circumference 102 and can independently change their pan angles on the same circumference 102.

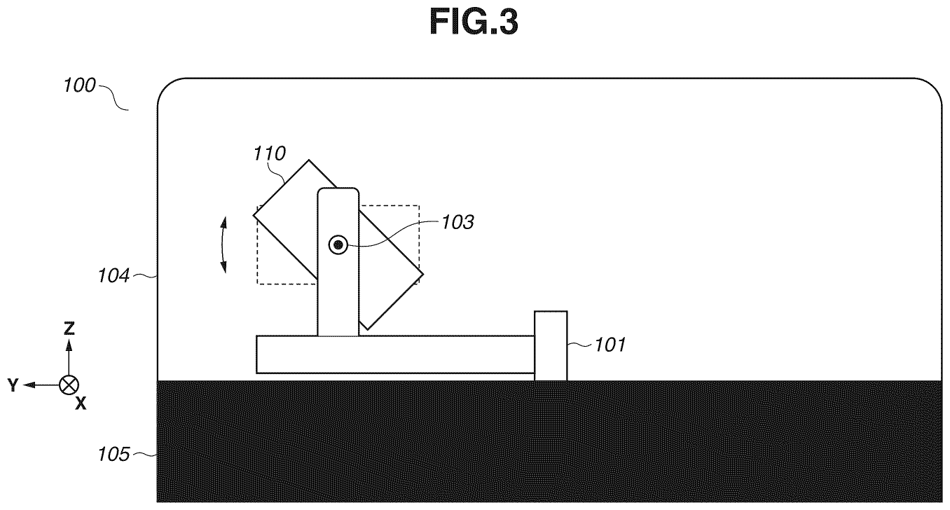

The tilt driving units 116, 126, 136, and 146 will be described with reference to FIG. 3. FIG. 3 is a diagram illustrating the imaging apparatus 100 according to the first exemplary embodiment as seen from a side (−X-axis side). The tilt driving units 116, 126, 136, and 146 include a motor and a gear each, and drive the respective imaging units 110, 120, 130, and 140 by controlling power to drive the motors.

The tilt driving unit 116 is configured to be rotatable with a shaft 103 as the rotation axis. The power to drive the motor is controlled by the control unit 152. The imaging apparatus 100 can independently drive the imaging units 110, 120, 130, and 140, and can independently drive one or more of the tilt driving units 116, 126, 136, and 146 at the same time.

A dome 104 is formed of a transparent member such as plastic and glass, and the imaging unit 110 can capture images of the surroundings outside the imaging apparatus 100. A fixing unit 105 is a fixing member to be attached to a ceiling, floor, or wall.

Unlike the pan driving units 114, 124, 134, and 144, the tilt driving units 116, 126, 136, and 146 do not cause physical interference between the imaging units 110, 120, 130, and 140. Similarly, the zoom driving units 115, 125, 135, and 145, the focus driving units 118, 128, 138, and 148, and the rotation driving units 117, 127, 137, and 147 do not cause physical interference between the imaging units 110, 120, 130, and 140.

### Zoom Driving Units/Focus Driving Units

The zoom driving units 115, 125, 135, and 145 include a motor and a gear each, and can drive the zoom lenses included in the respective imaging optical systems 111, 121, 131, and 141 by controlling power to drive the motors. The zoom driving units 115, 125, 135, and 145 further include configurations capable of acquiring the positions of the zoom lenses using photointerrupters or Hall elements.

The angles of view (zoom magnifications) of the imaging units 110, 120, 130, and 140 can be changed by driving the zoom driving units 115, 125, 135, and 145. The power to drive the motors is controlled by the control unit 152. The imaging apparatus 100 can independently drive the imaging units 110, 120, 130, and 140, and can independently drive one or more of the zoom driving units 115, 125, 135, and 145 at the same time.

The focus driving units 118, 128, 138, and 148 include a motor and a gear each, and can drive the focus lenses included in the respective imaging optical systems 111, 121, 131, and 141 by controlling power to drive the motors. The focus driving units 118, 128, 138, and 148 further include configurations capable of acquiring the positions of the focus lenses using photointerrupters or Hall elements. The focus positions (in-focus positions) of the imaging units 110, 120, 130, and 140 can be changed by driving the focus driving units 118, 128, 138, and 148. The power to drive the motors is controlled by the control unit 152. The imaging apparatus 100 can independently drive the imaging units 110, 120, 130, and 140, and can independently drive one or more of the focus driving units 118, 128, 138, and 148 at the same time.

### Rotation Driving Units

The rotation driving units 117, 127, 137, and 147 include a motor and a gear each, and can independently control the imaging units 110, 120, 130, and 140 by controlling power to drive the motors. Imaging regions having landscape aspect ratios can be changed into portrait aspect ratios by rotating the rotation driving units 117, 127, 137, and 147 by 90° with their optical axis directions as the axes. The rotation driving units 117, 127, 137, and 147 can be rotated within the range of 0° to 360°, not necessarily 90°. With 0° as the reference, the state of being at 0° is referred to as having a landscape aspect ratio.

### Communication Unit

The communication unit 153 transfers the images transmitted from the image processing unit 151 to the client apparatus 200 via the network 170 that is a wired or wireless network. The communication unit 153 accepts instructions from the client apparatus 200.

### Control Unit

The control unit 152 includes a central processing unit (CPU) that controls the imaging units 110, 120, 130, and 140, the driving units 113, 123, 133, and 143, the image processing unit 151, and the communication unit 153 as described above. The control unit 152 controls the imaging apparatus 100 in a comprehensive manner.

### Recording Unit

The recording unit 154 includes a random access memory (RAM) and a read-only memory (ROM). The recording unit 154 temporarily stores computer programs, and stores programs for the control unit 152 to control the imaging apparatus 100.

### Client Apparatus

The client apparatus 200 includes a communication unit 201, a control unit 202, a display unit 203, an instruction unit 204, and a recording unit 205.

The communication unit 201 of the client apparatus 200 can communicate with the imaging apparatus 100 via the network 170.

The display unit 203 is a displace device such as a display monitor, and can display a display image transmitted from the imaging apparatus 100.

The instruction unit 204 includes a user interface. The instruction unit 204 accepts mouse (pointing device) and keyboard operations made by the user, and generates control signals for the control unit 202 to control the imaging apparatus 100. Examples of the control signals include ones for controlling the driving units 113, 123, 133, and 143.

In other words, the user can control the pan/tilt driving units and the zoom magnifications of the imaging units 110, 120, 130, and 140 from the client apparatus 200 via the network 170. The user can also control the imaging apparatus 100 as described above by operating a graphical user interface (GUI) in the display image using a mouse. While the mouse is mentioned as an example, other means such as touchscreen operations may be used.

Examples of the client apparatus 200 include devices such as a personal computer. The network 170 includes a wired local area network (LAN) and/or a wireless LAN. The client apparatus 200 may be configured to supply power to the imaging apparatus 100 via the network 170.

The control unit 202 includes CPU functions, and controls the client apparatus 200 in a comprehensive manner. The recording unit 205 includes a RAM and a ROM. The recording unit 205 temporarily stores computer programs, and stores programs for the control unit 202 to control the client apparatus 200.

### Image Processing Unit

The image processing unit 151 performs development processing (operations) on captured data (captured images) captured by the imaging units 110, 120, 130, and 140 based on a display format. For example, if there are four imaging units 110, 120, 130, and 140, and four images are to be simultaneously displayed, the image processing unit 151 tiles the pieces of image data in two rows and two columns and develops the pieces of image data into a single display image.

The image processing unit 151 includes an object detection unit 161. The object detection unit 161 analyzes the acquired captured images by image processing. For example, in the case of detecting a moving body as an object, the object detection unit 161 calculates differences in luminance between the frames of the captured images. If there is a change in luminance, the object detection unit 161 determines that a moving body is detected. The user can instruct what to detect as an object via the instruction unit 204.

The image processing unit 151 can display (superimpose) a GUI on the captured data as an on-screen display (OSD). The superimposed OSD is a GUI the user can operate.

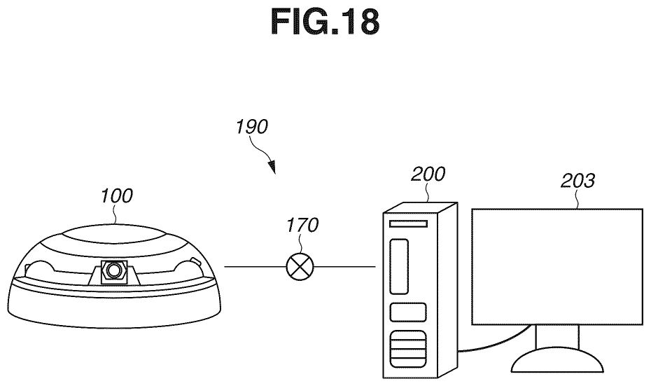

A configuration example of the imaging system 190 will be described with reference to FIG. 18. FIG. 18 is a diagram illustrating the configuration example of the imaging system 190 according to the present exemplary embodiment. The imaging system 190 includes the imaging apparatus 100, the network 170, the client apparatus 200, and the display unit 203.

The imaging apparatus 100 is connected to the client apparatus 200 via the network 170. While FIG. 18 illustrates a desktop personal computer as an example of the client apparatus 200, a laptop personal computer or a tablet where the client apparatus 200 and the display unit 203 are integrated may be used.

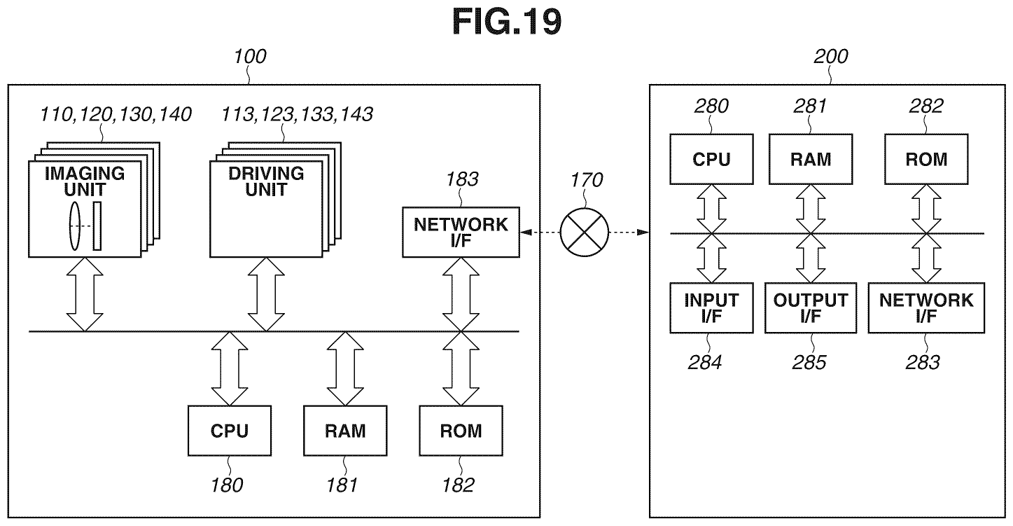

Details of the configuration of the imaging apparatus 100 and the client apparatus 200 will be described with reference to FIG. 19. FIG. 19 is a diagram illustrating a detailed configuration example of the imaging apparatus 100 and the client apparatus 200 according to the first exemplary embodiment.

The imaging apparatus 100 includes the imaging units 110, 120, 130, and 140, the driving units 113, 123, 133, and 143, a network interface (I/F) 183, a CPU 180, a RAM 181, and a ROM 182.

The CPU 180 is a CPU that controls the imaging apparatus 100 in a comprehensive manner. The CPU 180 controls the control unit 152, the image processing unit 151, and the communication unit 153 of FIG. 1.

The RAM 181 temporarily stores computer program for the CPU 180 to execute. The RAM 181 also provides a work area that the CPU 180 uses when performing processing. The RAM 181 also functions as a frame memory and a buffer memory.

The ROM 182 stores programs for the CPU 180 to control the imaging apparatus 100.

The network I/F 183 transmits the developed display image to the client apparatus 200 via the network 170. The image data captured by the imaging units 110, 120, 130, and 140 may be stored in an internal storage device such as the RAM 181 and the ROM 182 to be described below, or a not-illustrated removable storage medium such as a memory card.

The client apparatus 200 is an information processing apparatus including a CPU 280, a RAM 281, a ROM 282, an input I/F 284, an output I/F 285, and a network I/F 283.

The CPU 280 is a CPU that controls the client apparatus 200 in a comprehensive manner.

The RAM 281 provides a work area that the CPU 280 uses when performing data processing. The RAM 281 also functions as a frame memory and a buffer memory.

The ROM 282 stores programs for the CPU 280 to control the client apparatus 200.

The input I/F 284 is an I/F for connecting to the instruction unit 204 of FIG. 1 and accepting operations on the client apparatus 200, input by the user via the instruction unit 204. The input I/F 284 can also accept operation information for the imaging apparatus 100.

The output I/F 285 is an I/F for connecting to the display unit 203 of FIG. 18 and displaying the display image output from the imaging apparatus 100 on the display unit 203.

The network I/F 283 is an I/F for connecting to the imaging apparatus 100 via the network 170 and inputting the operation information for the imaging apparatus 100, input through the input I/F 284, to the imaging apparatus 100. The network I/F 283 also accepts the display image output from the imaging apparatus 100.

### Flowchart

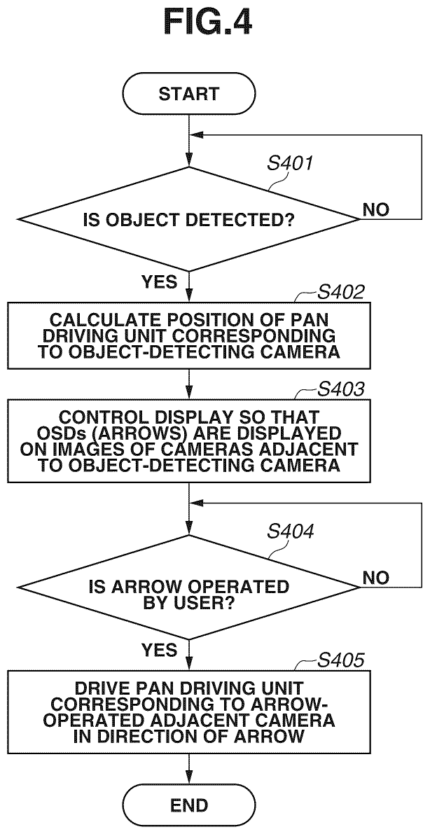

An operation of the imaging apparatus 100 during object detection will now be described with reference to FIG. 4. FIG. 4 is a flowchart illustrating a control method of the imaging apparatus 100 according to the first exemplary embodiment, a flowchart during object detection. This flowchart is implemented by the CPU 180 of the imaging apparatus 100 executing a program loaded into the RAM 181. Here, the imaging apparatus 100 is an example of a control apparatus. The plurality of imaging units 110, 120, 130, and 140 is built-in in the imaging apparatus 100.

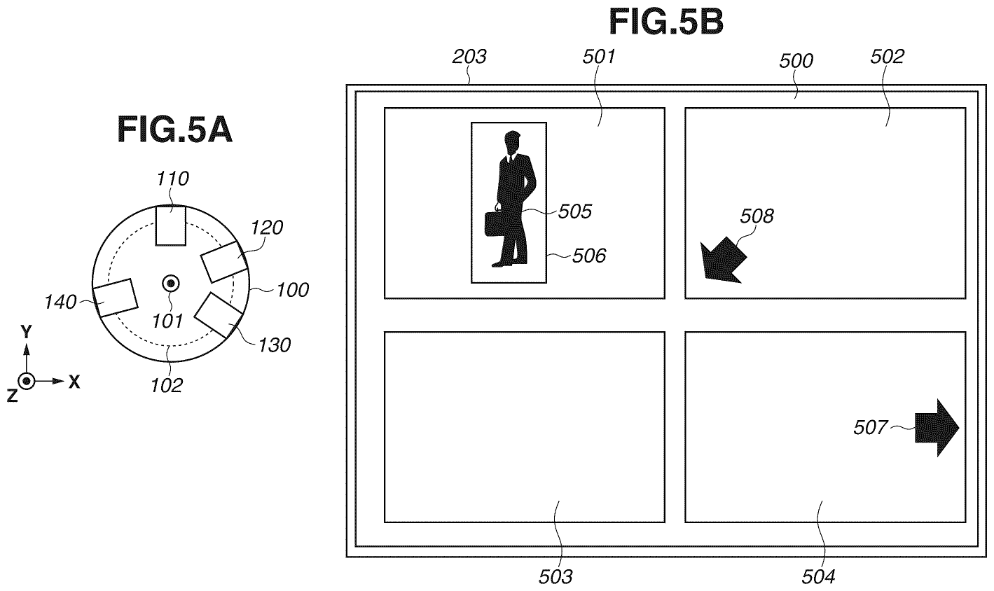

In step S401, the CPU 180 functions as the object detection unit 161 and determines whether an object is detected from the images captured by the plurality of imaging units 110, 120, 130, and 140. For example, as illustrated in FIG. 5B, the object detection unit 161 detects a moving body 505 in an image 501 captured by the imaging unit 110 as an object. If no object is detected (NO in step S401), the processing returns to step S401. The CPU 180 thereby enters a standby state. If an object is detected (YES in step S401), the processing proceeds to step S402.

In step S402, the CPU 180 calculates the position of the pan driving unit of the driving unit corresponding to the imaging unit by which the object is detected among the imaging units (cameras) 110, 120, 130, and 140.

In step S403, the CPU 180 controls the display on the display unit 203 so that OSDs indicating object-detected directions are displayed on the images of imaging units (hereinafter, referred to as adjacent cameras) adjacent to the imaging unit detecting the object (hereinafter, referred to as an object-detecting camera). An example of the OSDs indicating the object-detected directions is an arrow pointing toward the object-detecting camera viewed from an adjacent camera. Details will be described below with reference to FIGS. 5A and 5B.

For example, the CPU 180 functions as the control unit 152 and controls the display so that the image 501 where the moving body (object) 505 is detected, images 502 and 504 of the imaging units 120 and 140 adjacent on both sides of the imaging unit 110 capturing the image 501 where the moving body 505 is detected, and an image 503 are displayed on the display unit 203. The CPU 180 also controls the display on the display unit 203 so that arrows (images) 507 and 508 indicating directions toward the moving body 505 are superimposed on the images 502 and 504 of the imaging units 120 and 140 adjacent on both sides.

In step S404, the CPU 180 determines whether the user operates (clicks or taps) an arrow displayed as an OSD, using the client apparatus 200. If the user does not operate the arrows (NO in step S404), the processing returns to step S404. The CPU 180 thereby enters a standby state. If the user operates an arrow (YES in step S404), the processing proceeds to step S405.

In step S405, the CPU 180 drives the pan driving unit of the arrow-operated adjacent camera in the direction toward the object-detecting camera (in the direction of the arrow).

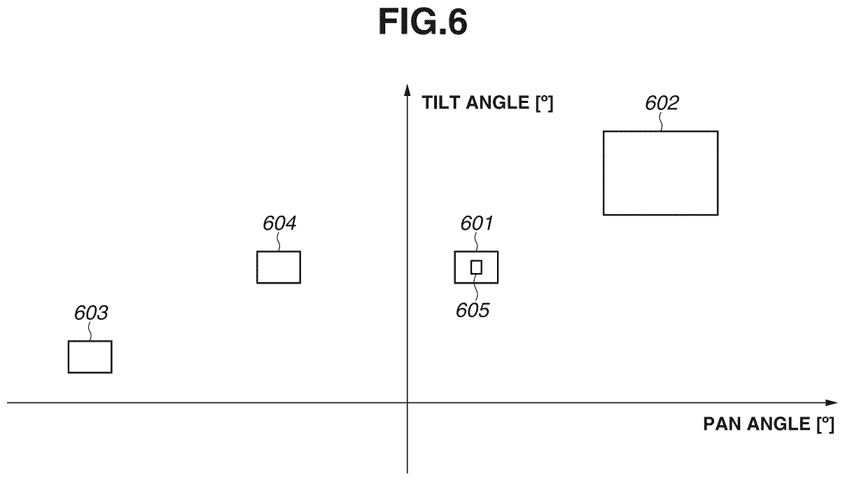

If the arrow 507 or 508 is operated, the CPU 180 issues instructions to bring an imaging region 602 or 604 (see FIG. 6) of the imaging unit 120 or 140 corresponding to the image 502 or 504 where the operated arrow 507 or 508 is displayed close to an imaging region 601 of the imaging unit 110 capturing the image 501 where the moving body 505 is detected.

Specifically, if the arrow 507 or 508 is operated, the CPU 180 issues instructions to bring the pan angle of the imaging unit 120 or 140 corresponding to the image 502 or 504 where the operated arrow 507 or 508 is displayed close to that of the imaging unit 110 capturing the image 501 where the moving body 505 is detected.

Moreover, if the arrow 507 or 508 is operated, the CPU 180 issues instructions to make at least one of the tilt angle, zoom magnification, focus position, and rotation angle of the imaging unit 120 or 140 corresponding to the image 502 or 504 where the operated arrow 507 or 508 is displayed the same as that of the imaging unit 110 capturing the image 501 where the moving body 505 is detected.

Furthermore, if the arrow 507 or 508 is operated, the CPU 180 issues instructions to make at least one of the exposure, gain, shutter speed, white balance, and gamma of the imaging unit 120 or 140 corresponding to the image 502 or 504 where the operated arrow 507 or 508 is displayed the same as that of the imaging unit 110 capturing the image 501 where the moving body 505 is detected.

The OSDs will be described with reference to FIGS. 5A and 5B. FIGS. 5A and 5B illustrate a display example of the OSDs according to the first exemplary embodiment. FIG. 5A is a structure diagram similar to FIG. 2. FIG. 5B illustrates how the images of the imaging units 110, 120, 130, and 140 are displayed on the display unit 203 of the client apparatus 200.

The display unit 500 of FIG. 5B is a display image developed by the image processing unit 151 and displayed on the display of the display unit 203. The image 501 is the image captured by the imaging unit 110. Similarly, the image 502 is the image captured by the imaging unit 120. The image 503 is the image captured by the imaging unit 130. The image 504 is the image captured by the imaging unit 140.

FIG. 5B illustrates an example where an object is detected by the imaging unit 110. The moving body 505 is captured within the angle of view of the imaging unit 110. The object detection unit 161 detects the moving body 505 when the moving body 505 moves to cause a difference in luminance between frames. If the moving body 505 is detected, the CPU 180 displays the detection result on the image 501 in a way that makes the detection result clear. The image 501 displays a frame 506 around the moving body 505 as the detection result.

If the object is detected by the imaging unit 110, the CPU 180 displays an arrow indicating the direction toward the object (arrow indicating the direction where the moving body 505 is detected) on the image 502 or 504 that is the image of an adjacent camera. Here, an example where arrows are displayed on both the images 502 and 504 will be described.

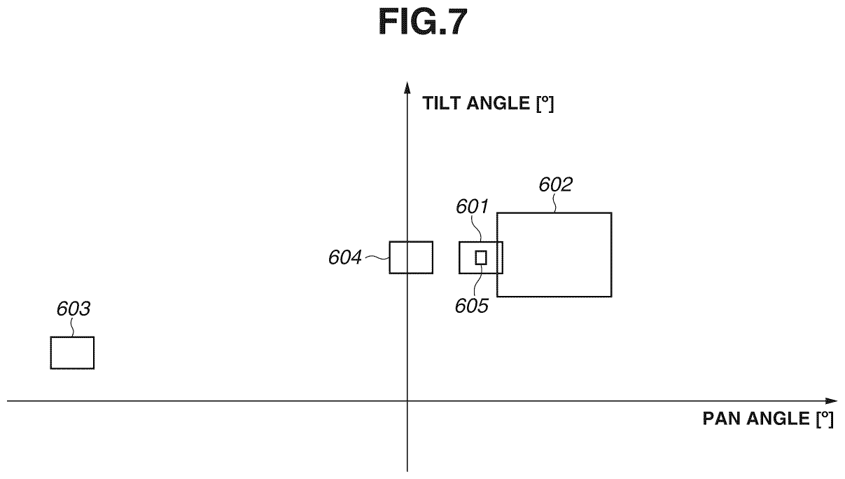

The CPU 180 displays the arrow 507 indicating the direction toward the object on the image 504 as an OSD. The arrow 507 is an OSD indicating the object-detected direction viewed from the imaging unit 140. The pan direction of the arrow 507 indicates a rightward direction that is the direction toward the object-detecting imaging unit 110. The tilt direction of the arrow 507 is desirably determined based on a positional relationship between the imaging units 140 and 110 and the position where the object is detected by the imaging unit 110. The arrow 507 represents a case where the center of the imaging angle of view of the imaging unit 140 matches the position of the frame (hereinafter, may be referred to as a detection frame) 506 in the tilt direction. The arrow 507 is displayed to point only in the pan direction. The pan and tilt positional relationships will be described below with reference to FIGS. 6 and 7.

The CPU 180 displays the arrow 508 indicating the direction toward the object on the image 502 as an OSD. The arrow 508 is an OSD indicating the object-detected direction viewed from the imaging unit 120. The horizontal direction of the arrow 508 indicates a leftward direction that is the direction toward the object-detecting imaging unit 110. The arrow 508 represents a case where the center of the imaging angle of view of the imaging unit 120 does not match the position of the detection frame 506 in the tilt direction. If the center of the imaging angle of view of the imaging unit 120 is located above the detection frame 506, the arrow 508 points to the bottom left as illustrated in FIG. 5B. On the other hand, if the center of the imaging angle of view of the imaging unit 120 is located below the detection frame 506, the arrow 508 points to the top left (not illustrated).

In such a manner, displaying the object-detected directions on the images of the adjacent cameras as OSDs enables the user to identify the directions where the object is. This can improve the user's operability and facilitate capturing images of the vicinity of where the object is detected.

The user's operability can be further improved by displaying the arrows 507 and 508 not only as direction-indicating OSDs but also as a GUI that the user can operate for pan/tilt driving. If the OSD of the arrow 507 or 508 is operated (tapped or clicked), the imaging apparatus 100 controls the pan driving unit, the tilt driving unit, the zoom driving unit, the focus driving unit, and the rotation driving unit of the imaging unit by which the image displaying the operated arrow is captured. Here, the imaging unit for which the arrow OSD is operated is driven based on the state of the pan driving unit, the tilt driving unit, the zoom driving unit, the focus driving unit, and the rotation driving unit of the object-detecting imaging unit.

For example, the tilt driving unit, the zoom driving unit, the focus driving unit, and the rotation driving unit of the adjacent camera are driven to the same positions as those of the object-detecting camera. Note that the pan driving unit is driven to a closest position within the drivable range since the pan driving units are unable to be located at the same position because of interference.

Consequently, the user can observe the vicinity of the object more easily by clicking the arrows. Capturing the vicinity of the imaging region of an object-detecting camera using adjacent cameras will be referred to as complementary imaging. By displaying the OSDs as a GUI and automatically performing complementary imaging when the OSDs are operated, the user's operability can be further improved to facilitate the imaging of the vicinity of where the object is detected.

The positional relationship, the imaging regions, and a detection region of the imaging units 110, 120, 130, and 140 will be described with reference to FIG. 6. FIG. 6 is a diagram illustrating the imaging regions of the imaging units 110, 120, 130, and 140 according to the first exemplary embodiment. FIG. 6 illustrates coordinates where the horizontal axis indicates the pan angle and the vertical axis the tilt angle.

The imaging region 601 corresponds to the imaging angle of view of the image 501 in FIG. 5B. Similarly, the imaging region 602 corresponds to the imaging angle of view of the image 502 in FIG. 5B. An imaging region 603 corresponds to the imaging angle of view of the image 503 in FIG. 5B. The imaging region 604 corresponds to the imaging angle of view of the image 504 in FIG. 5B.

The centers of the imaging regions 601, 602, 603, and 604 represent the positions of the pan and tilt angles of the imaging units 110, 120, 130, and 140, respectively. The sizes of the imaging regions 601, 602, 603, and 604 are determined by the sizes of the solid-state image sensors 112, 122, 132, and 142 of FIG. 1 and the optical characteristics of the imaging optical systems 111, 121, 131, and 141, respectively. The sizes of the imaging regions 601 to 604 change with the zoom magnifications. The imaging apparatus 100 records a table for determining the sizes of the imaging regions 601 to 604 beforehand, whereby the positions of the pan angles and the tilt angles at the boundaries of the imaging regions 601 to 604 can be calculated.

The imaging regions 601, 602, and 604 are illustrated with the same positional relationship as in the description of FIGS. 5A and 5B. The imaging regions 601 and 604 are located at the same tilt angles. The imaging regions 601 and 602 are located at different tilt angles. The detection frame 506 in FIG. 5B is illustrated as a detection region 605 in the imaging region 601.

The center of the imaging region 601 or the center of the detection region 605 may be determined as the object-detected position. Here, a case where the center of the imaging region 601 is determined as the object-detected position will be described.

In such a case, the positions of the pan driving unit 114 and the tilt driving unit 116 of the imaging unit 110 simply constitute the center coordinates of the imaging region 601. When the imaging region 601 is viewed from the imaging region 604, it can be seen that the imaging region 601 is located on the right of the imaging region 604. When the imaging region 601 is viewed from the imaging region 602, it can be seen from the imaging region 601 is located on the bottom left of the imaging region 602. The positional relationship between the imaging regions 601 to 604 can thus be notified to the user by using arrows.

The angles of the arrows displayed as OSDs may be determined by calculating vectors based on the relative positions of the pan and tilt driving units of the respective imaging units. The arrow OSDs may be displayed at angles of discrete values, like in units of 45°. The imaging apparatus 100 may determine whether the imaging units are located close to each other based on the lengths of the vectors.

The imaging regions 601 to 604 after the user clicks the arrow OSDs for pan/tilt driving will be described with reference to FIG. 7. FIG. 7 is a diagram illustrating the imaging regions 601 to 604 after the pan/tilt driving according to the first exemplary embodiment. FIG. 7 illustrates the imaging regions 601 to 604 after the imaging units 120 and 140 are driven from the state of FIG. 6.

A method for pan and tilt driving will now be described. Since the imaging region 604 is at the same tilt angle as that of the imaging region 601, the tilt driving unit 146 of the imaging unit 140 is not driven. There is a sufficient driving margin in the pan angle between the imaging regions 601 and 604, and the imaging unit 140 is thus driven by the pan driving unit 144 toward the imaging unit 110 until immediately before causing interference (to the closest position within the drivable range).

As for the imaging region 602, like the imaging region 604, the imaging unit 120 is driven by the pan driving unit 124 toward the imaging unit 110 up to the closest position within the drivable range. The imaging unit 120 is also driven by the tilt driving unit 126 to the same tilt angle position as that of the imaging unit 110.

The case where the center of the imaging region 601 is determined as the object-detected position has been described. A description will now be given of a case where the OSDs are displayed and the driving units are driven with respect to the center of the detection region 605.

The image processing unit 151 calculates the position of the pixel located at the center of the detection region 605 where the object is detected. As illustrated in FIGS. 6 and 7, the pan and tilt angles of the respective imaging units are controlled by the imaging apparatus 100, and the positional relationship between the imaging regions 601 to 604 is thus self-evident.

The image processing unit 151 corrects the positions of the pan driving units and the tilt driving units based on the position of the detection region 605 within the angle of view, the sizes of the solid-state image sensors, and the optical characteristics and zoom magnifications of the imaging optical systems. This enables the image processing unit 151 to calculate the positions of the pan driving units and the tilt driving units with respect to the position of the detection region 605.

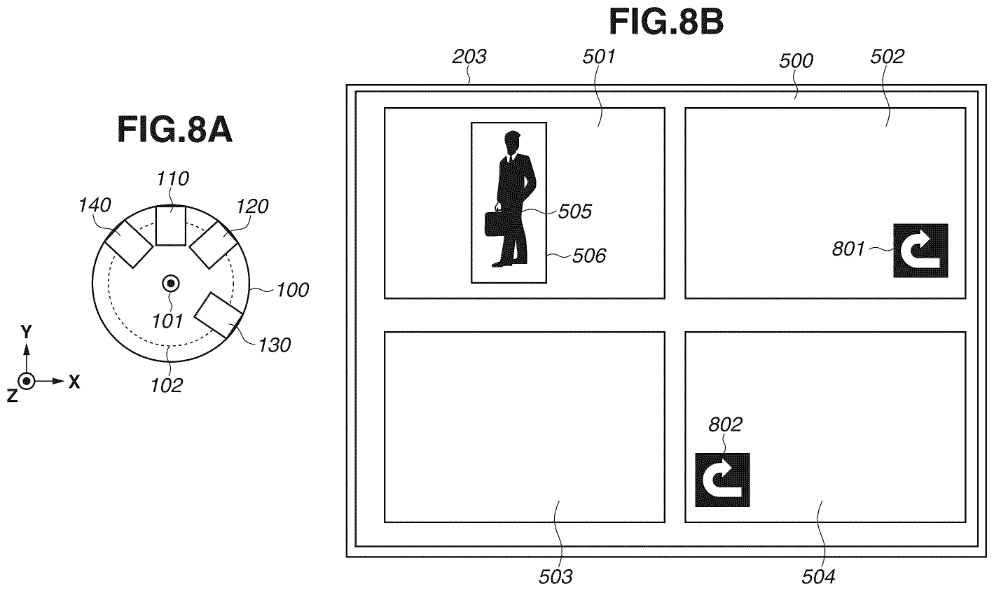

The control after the pan/tilt driving will be described with reference to FIGS. 8A and 8B. FIGS. 8A and 8B illustrate an example of OSDs for ending the complementary imaging using the pan/tilt driving units according to the first exemplary embodiment.

An end button 801 and an end button 802 are a GUI for ending the complementary imaging state where the imaging regions 602 and 604 are moved as illustrated in FIG. 7 and restoring the positions of the imaging regions 602 and 604 in FIG. 6.

If the arrow 507 or 508 is operated, the CPU 180 controls the display so that the user-operable end buttons 801 and 802 are displayed on the display unit 203. If the end button 801 or 802 is operated, the CPU 180 issues instructions to restore the position of the imaging region 602 or 604 of the imaging unit 120 or 140 corresponding to the operated end button 801 or 802.

The end buttons 801 and 802 may be represented by graphic figures such as those in FIG. 8B, or expressed by meaningful text such as “end”, “reference position”, and “home position”. Instead of displaying the end buttons 801 and 802 on the images as OSDs, a GUI may be displayed outside the image areas. The complementary imaging state may be ended after a lapse of certain time. Only one end button may be displayed, and if the end button is operated, the positions of all the imaging units may be restored to those of FIG. 6. While the arrow GUIs are described to be hidden, the arrow GUIs may be displayed with the end buttons.

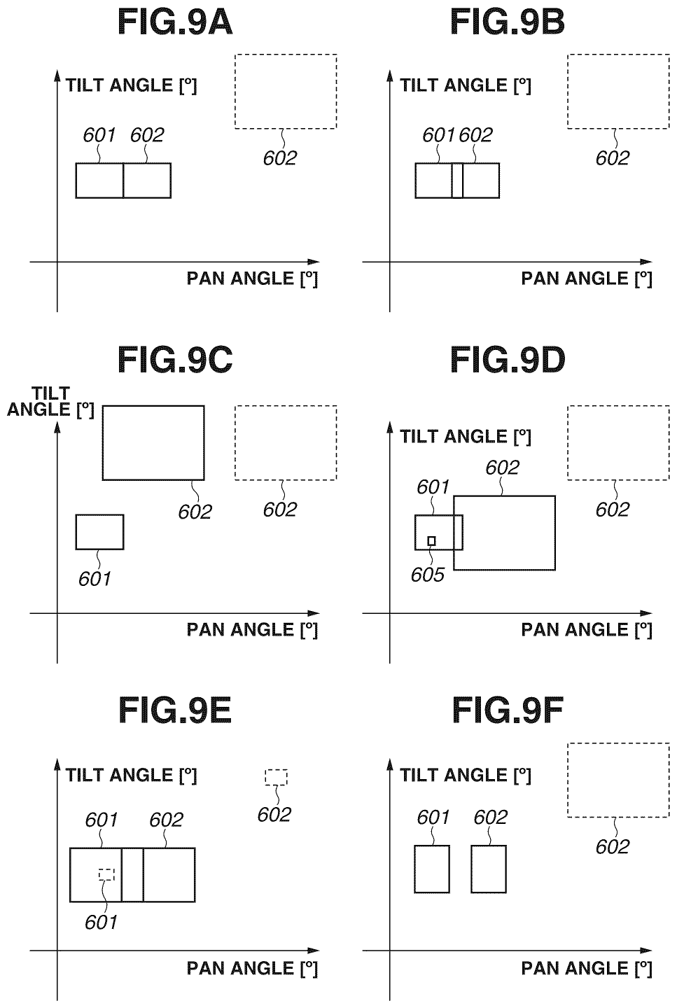

The operation of the driving units during complementary imaging will be further described with reference to FIGS. 9A to 9F. FIGS. 9A to 9F are diagrams illustrating examples of complementary imaging according to the first exemplary embodiment.

In complementary imaging, the adjacent cameras are driven toward the pan direction of the object-detecting imaging unit. However, the driving method is not uniquely determined. For example, in FIG. 7, the pan driving units 124 and 144 are described to be driven to the closest positions within the drivable ranges. Six examples of complementary imaging different from FIG. 7 will now be described with reference to FIGS. 9A to 9F.

In FIGS. 9A to 9F, operation examples of driving unit other than the pan driving units will also be described. These examples of complementary driving can be modified or combined. Like FIG. 6, FIGS. 9A to 9F illustrate cases where an object is detected in the imaging region 601 and complementary imaging is performed using the imaging region 602. For the sake of clear description, the other imaging regions 603 and 604 will be omitted. The imaging regions illustrated in dotted lines represent ones before the complementary imaging. The imaging regions illustrated in solid lines represent ones during the complementary imaging. In FIGS. 9A to 9F, the imaging regions illustrated only in solid lines represent ones that remain unchanged before and after the complementary imaging.

FIG. 9A illustrates an example where the pan angle of the imaging region 602 is changed to a position where the imaging region 602 approaches the imaging region 601 and the boundaries of the imaging regions 601 and 602 adjoin. The boundary of an imaging region can be calculated from the size of the solid-state image sensor and the optical characteristics and zoom magnification of the imaging optical system. In FIG. 9A, the zoom magnification and the tilt angle of the imaging region 602 are set to match those of the imaging region 601, and the pan angle is adjusted to the boundary of the imaging region 601. This can prevent the occurrence of dead angles.

Compared to FIG. 9A, FIG. 9B illustrates an example where the imaging regions 601 and 602 are located to overlap. In FIG. 9B, the pan angle may be brought closer to the imaging region 601 within the drivable range. The amount of overlap between the imaging regions 601 and 602 may be set, like 10% of the horizontal angle of view. This facilitates capturing images of the state near the border between the imaging regions 601 and 602.

FIG. 9C illustrates an example where only the pan driving unit 124 is driven during the complementary imaging. By bringing the pan angle of the imaging region 602 close to that of the imaging region 601 as in FIG. 9C, a position closer to the imaging region 601 than the dotted-lined imaging region 602 can be captured. The pan angle here is the same as in FIG. 9A or 9B. While the zoom magnification here is illustrated to remain unchanged before and after the complementary imaging, the zoom magnification may be changed. Changing the zoom magnification to wider angles can prevent the occurrence of dead angles and facilitate capturing an image of the vicinity of the imaging region of the object-detecting camera.

Compared to FIG. 9C, FIG. 9D illustrates an example where the tilt angle is adjusted to the same angle as that of the imaging region 601. Like the pan angle, bringing the tilt angle of the imaging region 602 close to that of the imaging region 601 helps capture an image of the vicinity of the imaging region 601 in a complementary manner. Since the tilt angle is not simply brought closer but adjusted to the same angle, the positional relationship between the imaging units 110 and 120 is aligned in the tilt angles and the user can view the images more easily. The tilt angle of the imaging region 602 may be adjusted to the center of the imaging region 601 or the detection region 605.

FIG. 9E illustrates an example where not only the zoom magnification of the adjacent camera but also the zoom magnification of the object-detecting camera is changed. High zoom magnifications during complementary imaging can bring the adjacent cameras closer and cause physical interference between the imaging units, resulting in a gap (dead angle). There occurs a gap between the imaging regions 601 and 602 in FIG. 7, i.e., a dead angle in the pan angle direction. The zoom magnification of the imaging region 601 during the complementary imaging is therefore changed to wider angles to reduce the dead angle. Here, the zoom magnification is desirably changed to wider angles until the dead angle disappears like FIGS. 9A and 9B. The zoom magnification may be changed in either one or both of the imaging regions 601 and 602.

FIG. 9F illustrates an example where the imaging region 601 is driven to rotate from 0° by +90° (rotation driving). In such a case, the imaging region 602 is also driven to rotate by +90° for complementary imaging. If the rotation driving units are at different angles, the rotation angle of the adjacent camera is set to the same angle as that of the object-detecting imaging unit. This can display the positional relationship in an easily understandable fashion when the user compares the two images.

Adjusting the position of the focus driving unit of the adjacent camera to that of the focus driving unit of the object-detecting camera during complementary imaging can facilitate focusing on the vicinity of the detected object.

Image-related parameters such as the exposure of the adjacent camera and the gain, shutter speed, white balance, and gamma of the solid-state image sensor may be adjusted to those of the object-detecting camera during complementary imaging. This can reduce differences in brightness and image quality between the images.

The case where a dead angle occurs in the pan angle direction has been described with reference to FIG. 9E. If the rotation angle is 90°, the angle of view in the pan angle direction can be widened by changing the rotation angle to 0°. In such a manner, a dead angle in the pan direction angle can be reduced by driving the rotation angle to a landscape aspect ratio.

Supplementary descriptions of the present exemplary embodiment will now be given.

### Object Detection Method

A method for detecting an object based on luminance differences between frames has been described. However, other methods may be used. For example, attribute authentication for determining whether an object is a person or a vehicle based on edge shapes of acquired images may be used as the object detection method. If the detection target of the edge detection is a moving body, the moving direction (motion vector) of the moving body can be calculated by determining differences between frames.

While examples of the object detection method have been described, an object may be detected using other methods.

### Supplementary Description of Case Where Driving Ranges Are Limited

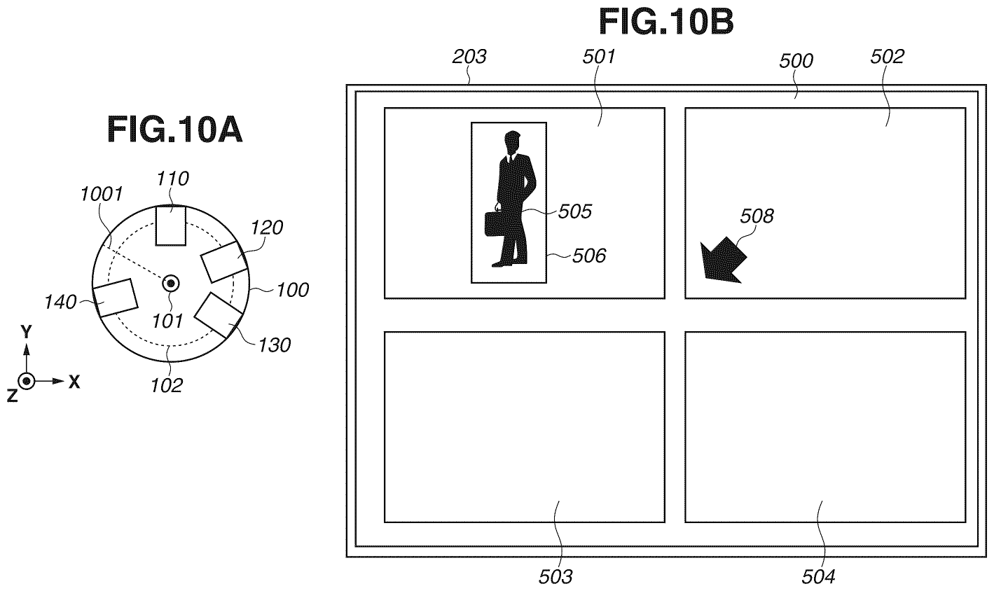

A case where the driving ranges are limited will be described with reference to FIGS. 10A and 10B. FIGS. 10A and 10B are diagrams illustrating the driving ranges according to the first exemplary embodiment.

FIG. 10A illustrates an example where a driving range restriction 1001 is added to FIG. 5A. The driving range restriction 1001 represents a position where the imaging units are unable to be driven by hardware due to physical interference or a position that is unable to be instructed by software (control unit 152).

Since the imaging units are unable to move to the position of the driving range restriction 1001, the imaging unit 140 can approach the imaging unit 110 only up to the driving range restriction 1001. In the presence of the driving range restriction 1001 between the imaging units 110 and 140, the imaging unit 140 is unable to be driven to near the imaging unit 110, and the OSD for the adjacent camera does not need to be displayed. In such a case, the imaging unit 120 is the only adjacent camera to display an OSD for, and the arrow 508 is displayed only on the image 502.

If the imaging unit 110 is located near the driving range restriction 1001, the imaging regions 601 and 604 may be able to overlap when the imaging unit 140 is brought close to the imaging unit 110. In such a case, the OSD may be displayed on the image 504 of the imaging unit 140 despite the presence of the driving range restriction 1001.

As described above, there can be cases where the driving range restriction 1001 exists. Here, the imaging unit 140 that is one of the imaging units 120 and 140 adjacent on both sides of the imaging unit 110 capturing the image 501 where the moving body 505 is detected is unable to move on the same circumference 102 toward the imaging unit 110 capturing the image 501 where the moving body 505 is detected.

The imaging unit 120 that is the other of the imaging units 120 and 140 adjacent on both sides of the imaging unit 110 capturing the image 501 where the moving body 505 is detected can move on the same circumference 102 toward the imaging unit 110 capturing the image 501 where the moving body 505 is detected.

In such a case, the CPU 180 controls the display so that the arrow 508 indicating the direction toward the moving body 505 is superimposed on the image 502 of the other imaging unit 120.

### Supplementary Description of Coordinates Where Object Is Detected

In FIG. 6, the center of the imaging region 601 is described to be determined as the object-detected position. A case where the center of the detection region 605 is determined as the object-detected position will now be described.

In calculating the coordinates where the object is detected from the positions of the object-detected pixels of the object-detecting imaging unit, the imaging apparatus 100 desirably has a coordinate system common among the imaging units.

If the center of the detection region 605 is determined as the object-detected position, the coordinates are calculated from the zoom magnifications and the positions of the object-detected pixels in addition to the pan and tilt angles of the imaging units.

### Supplementary Description of Effects

The reason for displaying the OSDs on the images of the adjacent cameras will be supplemented. For example, suppose that there are four imaging units. If an OSD is displayed on the image of the non-adjacent camera (=opposed camera) and the user attempts to move the opposed camera in the displayed direction, the opposed camera interferes with an adjacent camera and is unable to move.

Displaying the OSDs on only the images of the adjacent cameras can thus improve the user's operability.

### Supplementary Description of OSDs

In FIG. 5B, the heptagonal arrows 507 and 508 are described as examples of the OSDs indicating the object-detected directions. However, the numbers of corners and the shapes of the arrows 507 and 508 are not limited as long as the directions can be seen. The arrows 507 and 508 may be triangular or rectangular as long as the directions can be seen.

In FIG. 5B, the lengths of the arrows 507 and 508 may be changed depending on the relative positions of the object-detecting camera and the adjacent cameras. When the relative positions are far apart, the arrow may be made longer. When the relative positions are close, the arrow may be made shorter. This facilitates the user's understanding of the positional relationship with the object-detecting camera (or object-detected region).

When the OSDs indicating the object-detected directions are displayed, a GUI that enables the user to make pan/tilt operations may be displayed outside the frames of the images 501, 502, 503, and 504, separately from the OSDs.

### Supplementary Description of Positional Relationship

As illustrated in the configuration of FIG. 2, the imaging units 110, 120, 130, and 140 do not physically switch positions. The adjacent cameras of the object-detecting camera therefore do not switch positions. Moreover, the directions of the adjacent cameras toward the object-detecting camera are uniquely determined. While FIGS. 6, 7, and 9A to 9F have been described using the pan angles, OSDs indicating the object directions (right/left) can thus be displayed without calculating the pan angles.

### Coordinated Operation During Complementary Imaging

During complementary imaging, it is sometimes desirable to maintain the positional relationship between the object-detecting camera and the adjacent cameras. If the detection target is a moving body, the user may perform pan/tilt driving based on the movement of the moving body. When the user operates the driving unit of the object-detection camera, the adjacent cameras performing the complementary imaging in coordination with the object-detecting camera are desirably controlled as well.

For example, if the pan angle of the object-detecting camera is driven by +10°, the pan angles of the adjacent cameras are also driven by +10°. This eliminates the need to operate a plurality of imaging units during complementary imaging and improves the operability. While the user is described to operate the driving unit to follow the moving body, the same applies to situations where the imaging units are driven by automatic tracking. Automatic tracking is a technique for keeping the target object at a predetermined position within the angle of view (for example, at the center of the angle of view). Pan/tilt driving is performed by calculating the amount of movement and the moving direction of the target object.

When the imaging region 601 of the imaging unit 110 capturing the image 501 where the moving body 505 is detected moves, the CPU 180 issues instructions to move the imaging regions 602 and 604 of the adjacent imaging units 120 and 140 in a coordinated manner.

Operating the driving units of the adjacent cameras in coordination with the operation of the driving unit of the object-detecting camera in such a manner eliminates the need for the user to operate the adjacent cameras. This improves the operability.

While the coordinated pan driving operation has been described, the same applies to the driving units other than the pan driving units.

### Method for Operating OSDs for Adjacent Cameras

FIG. 5B illustrates an example where there are two adjacent cameras and OSDs are displayed on both images. However, an OSD may be displayed on either one of the images. When OSDs are displayed on both images, the user can get confused in operation because there are more images to pay attention to. In view of this, four methods for the imaging apparatus 100 to determine which adjacent camera's image to display the OSD on will be described.

In a first method, the motion vector of the moving body 505 is calculated based on frame-to-frame differences, and the OSD is displayed on the image of the adjacent camera located in the traveling direction (panning direction) of the moving body 505. The object detection unit 161 detects the moving direction of the moving body 505. The CPU 180 controls the display so that the arrow 507 or 508 indicating the direction toward the moving body 505 is superimposed on the image 502 or 504 of the imaging unit 120 or 140 located in the moving direction of the moving body 505, between the imaging units 120 and 140 adjacent on both sides of the imaging unit 110 capturing the image 501 where the moving body 505 is detected. This facilitates capturing an image of the moving body 505 with the adjacent camera even if the moving body 505 moves out of the angle of view of the object-detecting camera.

In a second method, the determination is made based on the relative positions in terms of the pan angles. The OSD is displayed on the image of the adjacent camera of which the relative position to the object-detection camera in terms of the pan angles is closer between the adjacent cameras. This enables the adjacent camera capturing an image near the object-detecting camera to capture an image of the vicinity. While the pan angles have been described as an example, the relative distances between the imaging units may be similarly calculated using the tilt angles, and the determination may be made based on the relative distances. In such a case, the CPU 180 controls the display so that the arrow indicating the direction toward the moving body 505 is superimposed on the image 502 or 504 of the imaging unit 120 or 140 capturing the imaging region 602 or 604 closer to the imaging region 601 of the imaging unit 110 capturing the image 501 where the moving body 505 is detected, between the imaging units 120 and 140 adjacent on both sides of the imaging unit 110 capturing the image 501 where the moving body 505 is detected.

In a third method, the adjacent camera to display the OSD for is determined based on the position of the frame 506 of the detection region within the angle of view of the object-detecting camera. For example, in FIG. 5B, the image 501 is divided into two in the pan angle direction. If the frame 506 of the detection region is in the right portion of the image 501, the OSD is displayed on the image 502 of the imaging unit 120 on the right of the imaging unit 110. On the other hand, if the frame 506 of the detection region is in the left portion of the image 501, the OSD is displayed on the image 504 of the imaging unit 140 on the left of the imaging unit 110. Alternatively, the image 501 may be divided into three in the pan direction. If the detection frame 506 is in the center portion, the OSD may be displayed on the image of either one of the adjacent cameras. If the moving body 505 is detected in the right portion of the image 501 where the moving body 505 is detected, the CPU 180 controls the display so that the arrow 508 indicating the direction toward the moving body 505 is superimposed on the image 502 of the imaging unit 120 adjacent on the right of the imaging unit 110 capturing the image 501 where the moving body 505 is detected. If the moving body 505 is detected in the left portion of the image 501 where the moving body 505 is detected, the CPU 180 controls the display so that the arrow 507 indicating the direction toward the moving body 505 is superimposed on the image 504 of the imaging unit 140 adjacent on the left of the imaging unit 110 capturing the image 501 where the moving body 505 is detected. The OSD can thereby be displayed on the image of the adjacent camera that can capture an image of the vicinity of the object-detected region more easily.

In a fourth method, the determination is made based on the layout of the images of the object-detecting camera and the adjacent cameras. For example, in FIG. 5B, the four images of the imaging units are tiled in two rows and two columns, and it is only the image 502 that is located laterally adjacent to the image 501. The OSD is therefore displayed on the image 502 which is captured by the adjacent camera (imaging unit 120). The CPU 180 controls the display so that the image 502 of the imaging unit 120 that is one of the imaging units 120 and 140 adjacent on both sides of the imaging unit 110 capturing the image 501 where the moving body 505 is detected is displayed at a position laterally adjacent to the image 501 where the moving body 505 is detected. The CPU 180 also controls the display so that the image 504 of the imaging unit 140 that is the other of the imaging units 120 and 140 adjacent on both sides of the imaging unit 110 capturing the image 501 where the moving body 505 is detected is displayed at a position not laterally adjacent to the image 501 where the moving body 505 is detected. The CPU 180 controls the display so that the arrow 508 indicating the direction toward the moving body 505 is superimposed on the image 502 of the one imaging unit 120. This improves visibility since the user can simply check the images arranged side by side.

As described above, narrowing images to display OSDs to that of one adjacent camera improves the user's operability since the user does not need to determine which adjacent camera to pay attention to.

### Method for Determining Whether to Display OSDs Based on Relative Distances

The imaging apparatus 100 may determine whether to display the OSDs based on the relative distances between the object-detecting camera and the adjacent cameras. If the relative distances are less than a threshold (cameras are closer than a threshold), the OSDs are displayed.

If the distances between the imaging unit 110 capturing the image 501 where the moving body 505 is detected and the adjacent moving units 120 and 140 are less than the threshold, the CPU 180 controls the display so that the arrows 507 and 508 indicating the directions toward the moving body 505 are superimposed.

When the OSDs of the arrows 507 and 508 are displayed, the user can thus be informed that the adjacent cameras are sufficiently close.

### Number of Imaging Units

While the configuration with four imaging units has been described, the present exemplary embodiment is applicable to an imaging apparatus 100 that includes at least two imaging units including an object-detecting camera and an adjacent camera. The number of imaging units is desirably four or more.

### Highlighting

The images for the user to pay attention to can be made more visible by highlighting the images of the object-detecting camera and/or the adjacent cameras. Highlighting refers to displaying the images 501, 502, and/or 503 of FIG. 5B in color frames, or displaying the images 501, 502, and/or 503 in a larger size.

The CPU 180 controls the highlighting of the image 501 where the moving body 505 is detected and either one or both of the images 502 and 504 of the adjacent imaging units 120 and 140.

### Electronic Zoom

An example where the zoom magnifications are changed by driving the zoom driving units has been described. However, the present exemplary embodiment is also applicable to electronic zoom using digital processing.

In the first exemplary embodiment, a method for performing the image processing by the image processing unit 151 of the imaging apparatus 100 has been described. A second exemplary embodiment deals with a case where the client apparatus 200 takes charge of at least some of the functions of the image processing unit 151. For example, object detection may be performed by the client apparatus 200. The image processing for displaying OSDs may be performed by the client apparatus 200.

Differences of the second exemplary embodiment from the first exemplary embodiment will now be described.

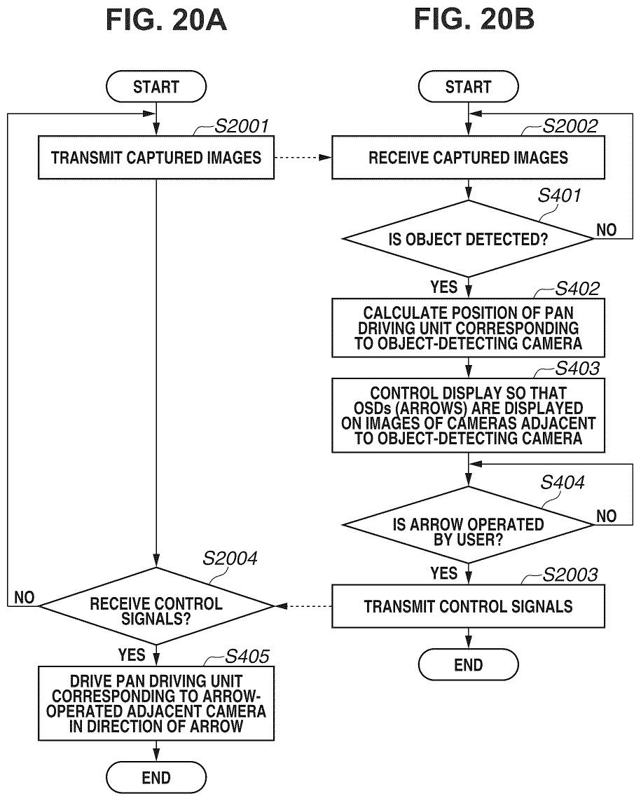

FIG. 20A is a flowchart illustrating a control method of the imaging apparatus 100 according to the second exemplary embodiment. FIG. 20B is a flowchart illustrating a control method of the client apparatus 200 according to the second exemplary embodiment. The flowchart of FIG. 20A is implemented by the CPU 180 of the imaging apparatus 100 executing a program loaded into the RAM 181. The flowchart of FIG. 20B is implemented by the CPU 280 of the client apparatus 200 executing a program loaded into the RAM 281. The client apparatus 200 is an example of a control apparatus. The plurality of imaging units 110, 120, 130, and 140 is disposed outside the client apparatus 200.

Steps S401 to S405 in FIGS. 20A and 20B correspond to steps S401 to S405 in FIG. 4. The imaging apparatus 100 performs the processing of steps S2001, S2004, and S405. The client apparatus 200 performs the processing of steps S2002, S401 to S404, and S2003.

In step S2001, the CPU 180 of the imaging apparatus 100 transmits images captured by the imaging units 110, 120, 130, and 140 to the client apparatus 200 via the network I/F 183 in units of frames of the captured images. The CPU 180 may transmit information about the pan angles, tilt angles, zoom magnifications, rotation angles, and focus positions of the imaging units 110, 120, 130, and 140 to the client apparatus 200 via the network I/F 183 in units of frames of the captured images as appropriate.

In step S2002, the CPU 280 of the client apparatus 200 receives the captured images of the imaging units 110, 120, 130, and 140 from the imaging apparatus 100 via the network I/F 283 in units of frames of the captured images. The CPU 280 may receive the information about the pan angles, tilt angles, zoom magnifications, rotation angles, and focus positions of the imaging units 110, 120, 130, and 140 from the imaging apparatus 100 via the network I/F 283 in units of frames of the captured images.

In step S401, the CPU 280 determines whether an object is detected from the images captured by the plurality of imaging units 110, 120, 130, and 140. For example, as illustrated in FIG. 5B, the CPU 280 detects the moving body 505 in the image 501 captured by the imaging unit 110.

If no object is detected (NO in step S401), the processing returns to step S2002. If an object is detected (YES in step S401), the processing proceeds to step S402.

In step S402, the CPU 280 calculates the position of the pan driving unit of the driving unit corresponding to the imaging unit by which the object is detected among the imaging units 110, 120, 130, and 140.

In step S403, the CPU 280 controls display on the display unit 203 so that OSDs indicating object-detected directions are displayed on the images of imaging units (adjacent cameras) adjacent to the imaging unit detecting the object (object-detecting camera), as illustrated in FIG. 5B. Examples of the OSDs indicating the object-detected directions include the arrows 507 and 508 of FIG. 5B.

For example, the CPU 280 functions as a control unit and controls the display so that the image 501 where the moving body (object) 505 is detected, the images 502 and 504 of the imaging units 120 and 140 adjacent on both sides of the imaging unit 110 capturing the image 501 where the moving body 505 is detected, and the image 503 are displayed on the display unit 203. The CPU 280 also controls the display on the display unit 203 so that the arrows (images) 507 and 508 indicating the directions toward the moving body 505 are superimposed on the images 502 and 504 of the adjacent imaging units 120 and 140.

In step S404, the CPU 280 determines whether the user operates (clicks or taps) an arrow displayed as an OSD, using the client apparatus 200. If the user does not operate the arrows (NO in step S404), the processing returns to step S404. The CPU 280 thereby enters a standby state. If the user operates an arrow (YES in step S404), the processing proceeds to step S2003.

In step S2003, to drive the arrow-operated adjacent camera toward the object-detecting camera (in the direction of the arrow), the CPU 280 transmits control signals regarding the pan angles, tilt angles, zoom magnifications, rotation angles, and focus positions of the imaging units 110, 120, 130, and 140 to the imaging apparatus 100 via the network I/F 283. For example, the CPU 280 transmits control signals for implementing the imaging regions 601 and 602 of the imaging units 110 and 120 such as illustrated in FIGS. 9A to 9F.

In other words, if the arrow 507 or 508 is operated, the CPU 280 issues, using the control signals, instructions to bring the imaging region 602 or 604 of the imaging unit 120 or 140 corresponding to the image 502 or 504 where the operated arrow 507 or 508 is displayed close to the imaging region 601 of the imaging unit 110 capturing the image 501 where the moving body 505 is detected.

Specifically, if the arrow 507 or 508 is operated, the CPU 280 issues instructions to bring the pan angle of the imaging unit 120 or 140 corresponding to the image 502 or 504 where the operated arrow 507 or 508 is displayed close to that of the imaging unit 110 capturing the image 501 where the moving body 505 is detected.

Moreover, if the arrow 507 or 508 is operated, the CPU 280 issues instructions to make at least one of the tilt angle, zoom magnification, focus position, and rotation angle of the imaging unit 120 or 140 corresponding to the image 502 or 504 where the operated arrow 507 or 508 is displayed the same as that of the imaging unit 110 capturing the image 501 where the moving body 505 is detected.

Furthermore, if the arrow 507 or 508 is operated, the CPU 280 issues instructions to make at least one of the exposure, gain, shutter speed, white balance, and gamma of the imaging unit 120 or 140 corresponding to the image 502 or 504 where the operated arrow 507 or 508 is displayed the same as that of the imaging unit 110 capturing the image 501 where the moving body 505 is detected.

In step S2004, the CPU 180 of the imaging apparatus 100 determines whether the control signals regarding the pan angles, tilt angles, zoom magnifications, rotation angles, and focus positions of the imaging units 110, 120, 130, and 140 are received from the client apparatuses 200 via the network I/F 183. If the control signals are not received (NO in step S2001), the processing returns to step S2001.

If the control signals are received (YES in step S2001), the processing proceeds to step S405.

In step S405, the CPU 180 controls the pan angles, tilt angles, zoom magnifications, rotation angles, and focus positions of the imaging units 110, 120, 130, and 140 based on the received control signals. Specifically, the CPU 180 drives the pan driving unit of the arrow-operated adjacent camera toward the object-detecting camera (in the direction of the arrow).

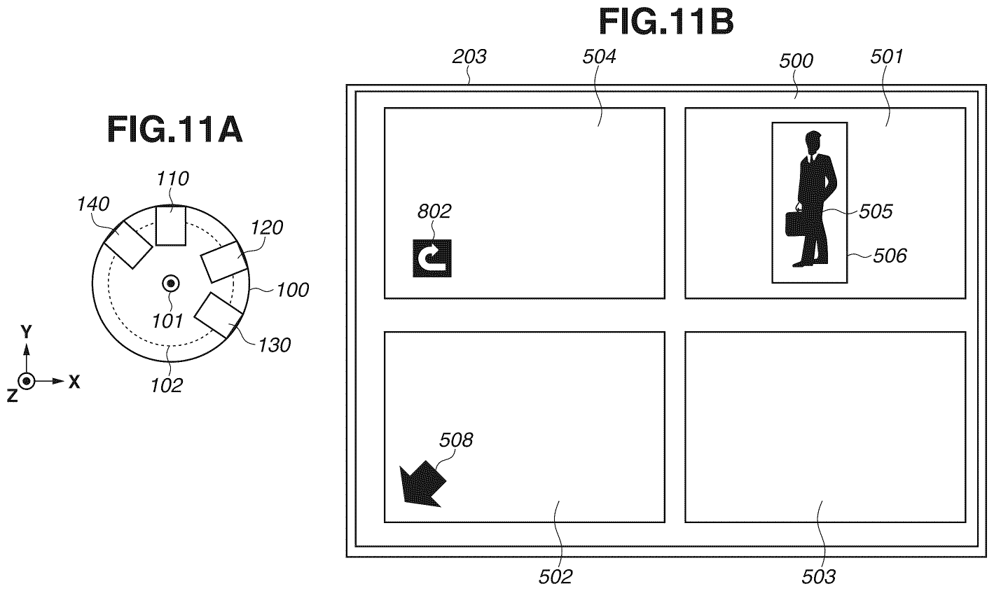

In the first exemplary embodiment, the OSDs displayed when an object is detected and the method for driving the pan driving units when the arrows displayed as the OSDs are operated have been described. In a third exemplary embodiment, how to arrange the images to be displayed on object detection will be described with reference to FIGS. 11A to 16. In the third exemplary embodiment, the images of an object-detecting camera and an adjacent camera are rearranged to be displayed side by side, whereby highly visible images that help the user understand the positional relationship of the imaging units is displayed.

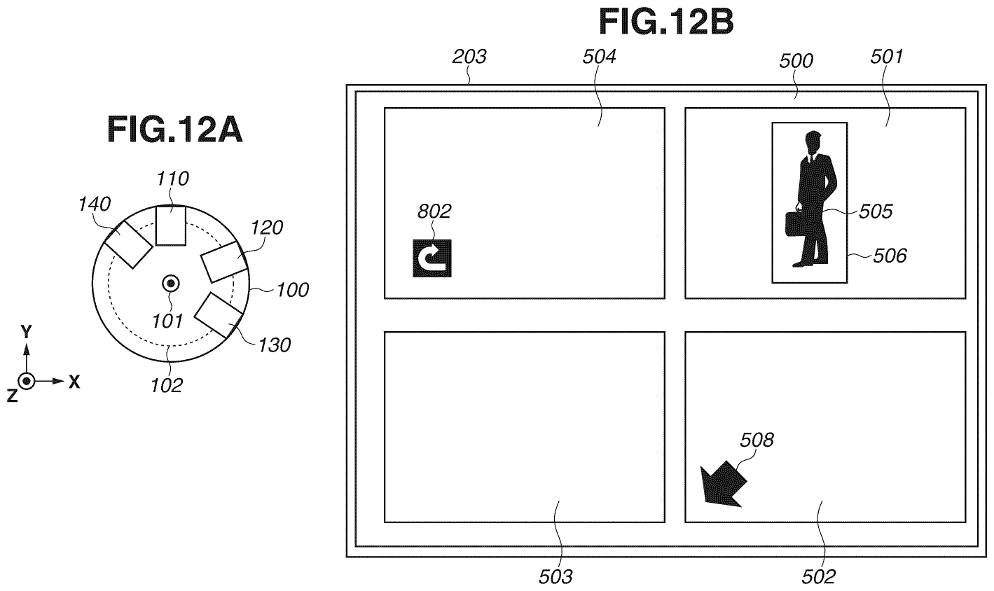

An example of rearranging the images 501 to 504 will be described with reference to FIGS. 11A to 12B.

FIGS. 11A and 11B are diagrams illustrating a display example according to the third exemplary embodiment, where the images 501 to 504 are each shifted by one. Compared to FIGS. 5A and 5B, FIGS. 11A and 11B illustrate an example where the displayed images 501 to 504 are rearranged.

FIG. 11B illustrates a case where the arrow 507 in FIG. 5B is operated and the imaging unit 140 performs complementary imaging with the imaging unit 110. Referring to FIG. 11B, a rearrangement method for a case where there are four imaging units 110, 120, 130, and 140 and the four images 501 to 504 are tiled in two rows and two columns will be described.

The imaging unit 140 approaches the imaging unit 110 and complements a region on the left of the image 501 in FIG. 11B. Arranging the image 504 on the left of the image 501 side by side thus helps the user to intuitively understand the positional relationship. Compared to FIG. 5B, FIG. 11B illustrates an example where the images 501 to 504 are each shifted by one so that the image 504 is arranged on the left of the image 501 side by side.

While FIG. 11B illustrates the example where the images 501 to 504 are each shifted by one, other methods may be used. Referring to FIGS. 12A and 12B, a display example where the images 501 to 504 are switched in position will be described. FIGS. 12A and 12B are diagrams illustrating a display example where the images 501 to 504 are shifted by switching positions.

In FIG. 12B, the images 501 and 502 in FIG. 5B are switched in position, and the images 502 and 504 are further switched in position. Like FIG. 11B, the image 504 can thereby be arranged on the left of the image 501 side by side.

As described above, in FIG. 5B, the CPU 180 controls the display so that the image 502 of the imaging unit 120 that is one of the imaging units 120 and 140 adjacent on both sides of the imaging unit 110 capturing the image 501 where the moving body 505 is detected is displayed at a position laterally adjacent to the image 501 where the moving body 505 is detected. The CPU 180 also controls the display so that the image 504 of the imaging unit 140 that is the other of the imaging units 120 and 140 adjacent on both sides is displayed at a position not laterally adjacent to the image 501 where the moving body 505 is detected.

When the arrow 507 displayed on the image 504 of the other imaging unit 140 is then operated, the CPU 180 controls the display so that the image 504 of the other imaging unit 140 is displayed at a position laterally adjacent to the image 501 where the moving body 505 is detected, as illustrated in FIG. 11B or 12B. The CPU 180 then controls the display so that the image 502 of the one imaging unit 120 is displayed at a position not laterally adjacent to the image 501 where the moving body 505 is detected.

While FIGS. 11A to 12B illustrate the cases where the arrow 507 of FIG. 5B is operated, such control may also be performed before the operation. For example, if there is only one adjacent camera due to the presence of a driving range restriction, the image of the one adjacent camera is arranged beside to match the positional relationship during the complementary imaging. The image of the object-detecting camera and the image of the camera of which the imaging region is closer between the two adjacent cameras may be arranged side by side.

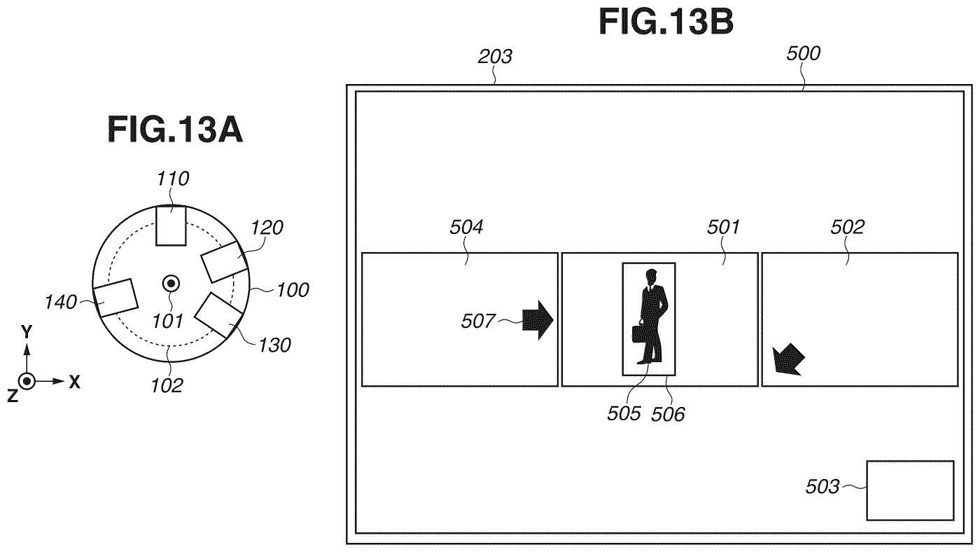

Next, an example where the images 502 and 504 of the adjacent cameras are arranged on both sides of the image 501 of the object-detecting camera will be described with reference to FIGS. 13A and 13B. FIGS. 13A and 13B are diagrams illustrating a display example where the images 502 and 504 of the adjacent cameras are arranged on both sides of the image 501 of the object-detecting camera.

Compared to FIG. 5B, FIG. 13B illustrates an example where the images are rearranged after object detection so that the images 502 and 504 of the adjacent cameras are located on both sides of the image 501 of the object-detecting camera. Like FIGS. 11A to 12B, the arrangement of the images 501 to 504 is determined based on the positional relationship between the object-detecting camera and the adjacent cameras.

If the images 501 to 504 have been tiled in two rows and two columns like FIG. 5B, not only the positions of the images 501 to 504 but the sizes or aspect ratios of the images 501, 502, 503, and 504 are changed to fit within the display range of the display unit 203. Since the object-detecting camera is of the highest attention, the image 501 is desirably not reduced in size compared to the other images 502 to 504. The image 503 is an image in which no object is detected, and may be reduced in size or hidden.

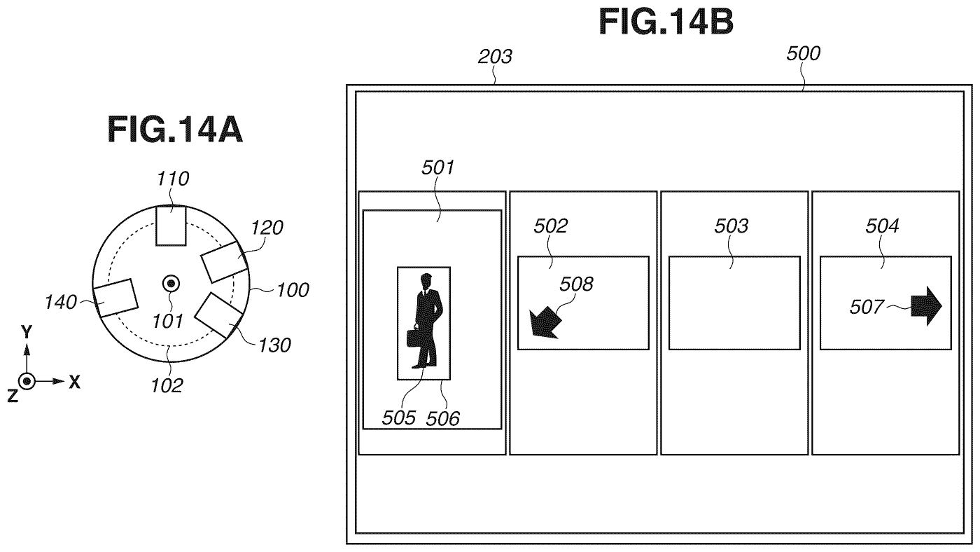

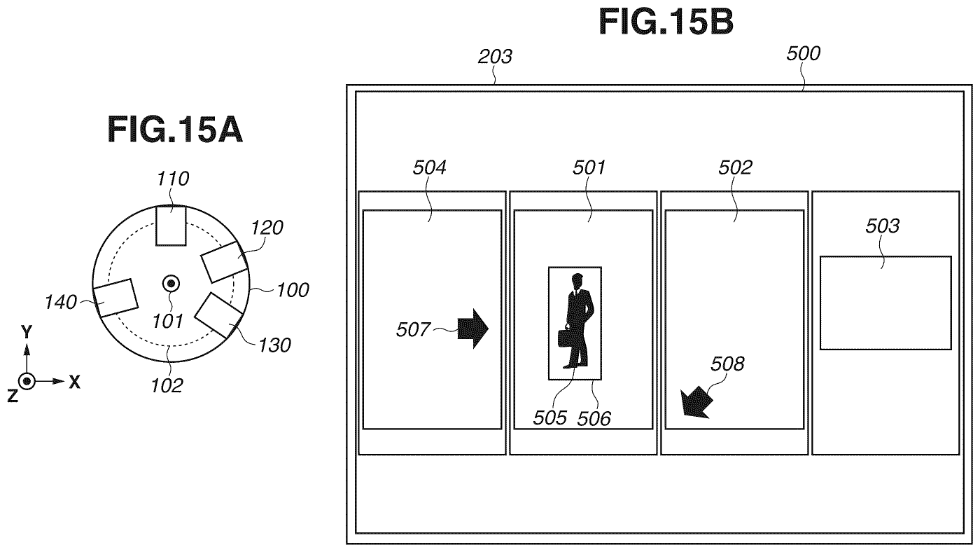

Next, a case where images for imaging in portrait orientation are displayed will be described with reference to FIGS. 14A to 15B.

A case where the image 501 is rotated by 90° and displayed for imaging in portrait orientation will be described with reference to FIGS. 14A and 14B. FIGS. 14A and 14B illustrate a display and arrangement example for imaging in portrait orientation. Compared to FIG. 5B where the images 501 to 504 are tiled in two rows and two columns, FIG. 14B illustrates an example where all the images 501 to 504 are laterally arranged side by side. All the images 501 to 504 are allocated portrait layout spaces.

The imaging unit 110 is rotated by 90° and captures the image 501 with a portrait angle of view. The other imaging units 120, 130, and 140 are not rotated and capture the images 502 to 504 with landscape angles of view.

The image 501 is displayed as rotated by 90° to match the rotation angle of the imaging unit 110. If the display range of the display unit 203 is landscape, the rotated image 501 arranged in portrait orientation as illustrated in FIG. 14B can be displayed in a large size compared to with the tiled image arrangement (landscape priority).

Next, a display rearrangement method and a method for driving the adjacent cameras when the object-detecting camera is rotated for imaging (rotation imaging) will be described with reference to FIGS. 15A and 15B. FIGS. 15A and 15B are diagrams illustrating a display example for the display rearrangement method and the method for driving the adjacent cameras during rotation imaging.

Compared to FIG. 14B, FIG. 15B illustrates display where the images 501 to 504 are rearranged. The images 502 and 504 of the adjacent cameras are arranged on both sides of the image 501 of the object-detecting camera. Moreover, in FIG. 15B, the adjacent cameras are rotated by 90° like the object-detecting camera as illustrated in FIG. 9F. Here, the images 502 and 504 of the adjacent cameras are displayed as rotated by 90° like the image 501 of the object-detecting camera. Since the images can be visually observed side by side, the user can easily view the images of the vicinity of the object in a complementary manner.

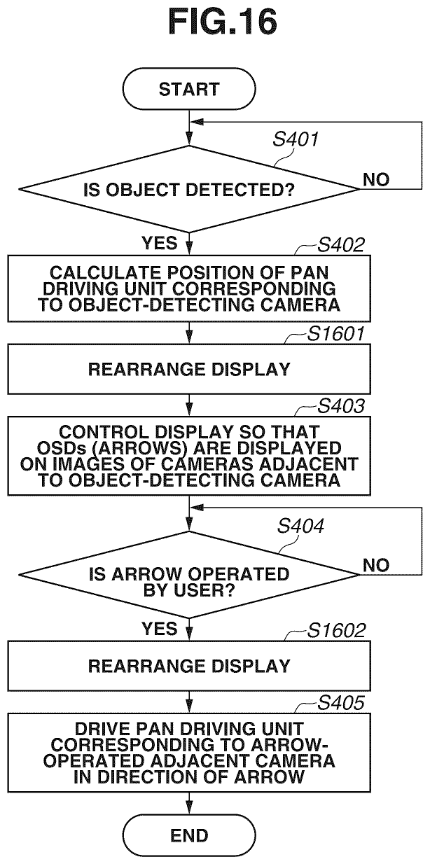

Next, the timing to rearrange the image display will be described with reference to FIG. 16. FIG. 16 is a flowchart for rearranging images. This flowchart is implemented by the CPU 180 of the imaging apparatus 100 executing a program loaded into the RAM 181. In FIG. 16, steps S1601 and S1602 for changing the display are added to the flowchart of FIG. 4. The timing to rearrange the images may be after an object is detected in step S401, like step S1601, or after an arrow displayed as an OSD is operated for driving, like step S1602.

After step S402, in step S1601, the CPU 180 rearranges the display of the images 501 to 504 on the display unit 203 as illustrated in FIG. 13B, 14B, or 15B, for example. The processing then proceeds to step S403.

After step S404, in step S1602, the CPU 180 rearranges the display of the images 501 to 504 on the display unit 203 as illustrated in FIGS. 11B or 12B, for example. The processing then proceeds to step S405.

As described above, the CPU 180 rearranges the images 501, 502, 503, and 504 of the plurality of imaging units 110, 120, 130, and 140 displayed on the display unit 203 after the moving body 505 is detected in step S401 or after the arrow 507 or 508 is operated in step S404.

Like the second exemplary embodiment, the processing of the steps S1601 and S1602 may be performed by the CPU 280 of the client apparatus 200.

While FIGS. 14A to 15B illustrate display examples for imaging in portrait orientation to match the rotated images, the images may be tiled in two rows and two columns regardless of the presence or absence of rotation. Alternatively, all the images may be displayed side by side with the landscape aspect ratios.

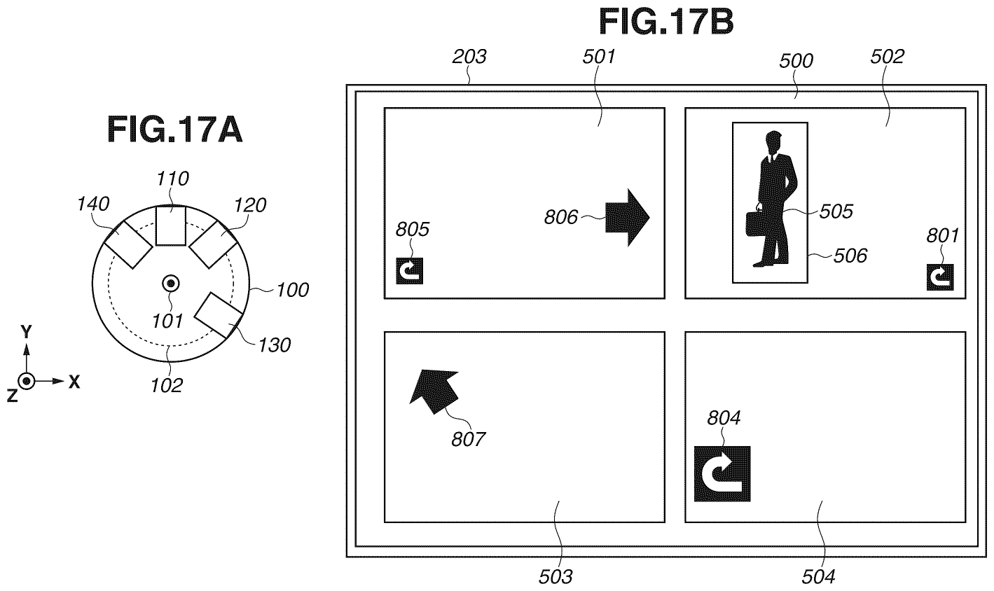

In a fourth exemplary embodiment, a case where an object being detected moves and the object-detecting camera is switched will be described with reference to FIGS. 17A and 17B. FIGS. 17A and 17B are diagrams illustrating an example according to the fourth exemplary embodiment, where the object has moved.

Compared to FIG. 8B, FIG. 17B illustrates a case where the moving body 505 captured in the imaging region of the imaging unit 110 has moved to the imaging region of the imaging unit 120. Here, the imaging units switch roles so that the imaging unit 120 serves as an object-detecting camera and the imaging units 110 and 130 as adjacent cameras.

If the moving body 505 moves from the image 501 of the imaging unit 110 by which the moving body 505 has been detected to the image 502 of another imaging unit 120, the object detection unit 161 detects the moving body 505 in the image 502 of the other imaging unit 120.

The CPU 180 controls the display so that arrows (images) 806 and 807 indicating the directions toward the moving body 505 are superimposed on the images 501 and 503 of the imaging units 110 and 130 adjacent to the other imaging unit 120.

Since the imaging unit 110 is adjacent to the imaging unit 120 serving as the new object-detecting camera, the positional relationship between the images 501 to 504 is desirably maintained. An end button 805 and the arrow 806 are therefore displayed on the image 501.

The imaging unit 140 is in an opposing positional relationship with the object-detecting imaging unit 120, and the driving unit 143 may therefore be driven to the position before the complementary imaging. FIG. 17B illustrates an example where an end button 804 is displayed on the image 504 so that the imaging unit 140 can be moved by user operation.

The imaging unit 130 serves as a new adjacent camera, and the arrow 807 is thus displayed on the image 503.

Even if the object has moved, changing the display method depending on the object-capturing image unit thus enables complementary imaging of the vicinity where the object is detected.

Like the second exemplary embodiment, the client apparatus 200 may perform the processing of the fourth exemplary embodiment.

As described above, according to the first to fourth exemplary embodiments, the imaging units 110, 120, 130, and 140 can be independently driven on the common circumference 102. The imaging system 190 facilitates capturing images in the vicinity of an imaging apparatus detecting an object and can improve operability.

### Other Exemplary Embodiments

The present disclosure can also be implemented by processing for supplying a program that implements one or more functions of the foregoing exemplary embodiments to a system or an apparatus via a network or a storage medium, and reading and executing the program by one or more processors in a computer of the system or apparatus. A circuit for performing one or more of the functions (for example, application-specific integrated circuit [ASIC]) may be used for implementation.

While the exemplary embodiments of the present disclosure have been described, the present disclosure is not limited to these exemplary embodiments, and various modifications and changes can be made without departing from the gist thereof.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-011178, filed Jan. 29, 2024, which is hereby incorporated by reference herein in its entirety.

What is claimed is:

1. A control apparatus comprising:
one or more memories storing a program; and
one or more processors executing the program to:
acquire a detection result of an object detected from images acquired by a plurality of respective imaging units configured to move independently on a same circumference;
control display of an image in which the object is detected and an image of an imaging unit adjacent to an imaging unit acquiring the image in which the object is detected on a display unit;
control superimposing an image related to the object on the image of the adjacent imaging unit.

2. The control apparatus according to claim 1, wherein the one or more processors execute the program to control superimposing the image related to the object on the images of imaging units adjacent on both sides of the imaging unit acquiring the image in which the object is detected.

3. The control unit according to claim 1,
wherein the object is a moving body, and
wherein the one or more processors execute the program to:
detect a moving direction of the moving body; and
control superimposing an image indicating a direction toward the moving body, as the image related to the object, on the image of an imaging unit located in the moving direction of the moving body between imaging units adjacent on both sides of the imaging unit acquiring the image in which the moving body is detected.

4. The control apparatus according to claim 1, wherein the one or more processors execute the program to control superimposing an image indicating a direction toward the object, as the image related to the object, on the image of an imaging unit capturing an imaging region closer to that of the imaging unit acquiring the image in which the object is detected between imaging units adjacent on both sides of the imaging unit acquiring the image in which the object is detected.

5. The control apparatus according to claim 1, wherein the one or more processors execute the program to:
control, in a case where the object is detected in a right portion of the image in which the object is detected, superimposing an image indicating a direction toward the object, as the image related to the object, on the image of an imaging unit adjacent on a right of the imaging unit acquiring the image in which the object is detected, and
control, in a case where the object is detected in a left portion of the image in which the object is detected, superimposing an image indicating a direction toward the object, as the image related to the object, on the image of an imaging unit adjacent on a left of the imaging unit acquiring the image in which the object is detected.

6. The control apparatus according to claim 1, wherein the one or more processors execute the program to:
control display of the image of one of imaging units adjacent on both sides of the imaging unit acquiring the image in which the object is detected at a position laterally adjacent to the image in which the object is detected,
control display of the image of another of the imaging units adjacent on both sides of the imaging unit acquiring the image in which the object is detected at a position not laterally adjacent to the image in which the object is detected, and
control superimposing an image indicating a direction toward the object on the image of the one imaging unit as the image related to the object.

7. The control apparatus according to claim 1, wherein the one or more processors execute the program to control, in a case where one of imaging units adjacent on both sides of the imaging unit acquiring the image in which the object is detected is unable to move on the same circumference toward the imaging unit acquiring the image in which the object is detected and another of the imaging units adjacent on both sides of the imaging unit acquiring the image in which the object is detected is able to move on the same circumference toward the imaging unit acquiring the image in which the object is detected, superimposing an image indicating a direction toward the object on the image of the another imaging unit as the image related to the object.

8. The control apparatus according to claim 1, where the image related to the object is an arrow.

9. The control apparatus according to claim 1, wherein the image related to the object is a first graphical user interface configured to be operated by a user.

10. The control apparatus according to claim 9, wherein the one or more processors execute the program to control, in a case where the first graphical user interface is operated, bringing an imaging region of an imaging unit corresponding to the image in which the first graphical user interface operated is displayed close to that of the imaging unit acquiring the image in which the object is detected.

11. The control apparatus according to claim 9, wherein the one or more processors execute the program to control, in a case where the first graphical user interface is operated, bringing a pan angle of the imaging unit corresponding to the image in which the first graphical user interface operated is displayed closer to that of the imaging unit acquiring the image in which the object is detected.

12. The control apparatus according to claim 9, wherein the one or more processors execute the program to control, in a case where the first graphical user interface is operated, making at least one of a tilt angle, zoom magnification, focus position, or rotation angle of the imaging unit corresponding to the image in which the first graphical user interface operated is displayed a same as that of the imaging unit acquiring the image in which the object is detected.

13. The control apparatus according to claim 9, wherein the one or more processors execute the program to control, in a case where the first graphical user interface is operated, making at least one of an exposure, gain, shutter speed, white balance, or gamma of the imaging unit corresponding to the image in which the first graphical user interface operated is displayed a same as that of the imaging unit acquiring the image in which the object is detected.

14. The control apparatus according to claim 9, wherein the one or more processors execute the program to:
control display of the image of one of imaging units adjacent on both sides of the imaging unit acquiring the image in which the object is detected at a position laterally adjacent to the image in which the object is detected,
control display of the image of another of the imaging units adjacent on both sides of the imaging unit acquiring the image in which the object is detected at a position not laterally adjacent to the image in which the object is detected,
control, in a case where the first graphical user interface displayed on the image of the another imaging unit is operated, display of the image of the another imaging unit at a position laterally adjacent to the image in which the object is detected, and display of the image of the one imaging unit at a position not laterally adjacent to the image in which the object is detected.

15. The control apparatus according to claim 9, wherein the one or more processors execute the program to rearrange the images of the plurality of imaging units displayed on the display unit after the object is detected or after the first graphical user interface is operated.

16. The control apparatus according to claim 9, wherein the one or more processors execute the program to:
control, in a case where the first graphical user interface is operated, display of a second graphical user interface configured to be operated by the user on the display unit, and
control, in a case where the second graphical user interface is operated, restoring a position of the imaging region of the imaging unit corresponding to the first graphical user interface operated.

17. The control apparatus according to claim 1,
wherein the object is a moving body, and
wherein the one or more processors execute the program to detect, in a case where the moving body moves from the image of the imaging unit detecting the moving body to the image of another imaging unit, the moving body in the image of the another imaging unit and control superimposing an image indicating a direction toward the moving body on the image of an imaging unit adjacent to the another imaging unit as the image related to the object.

18. The control apparatus according to claim 1, wherein the one or more processors execute the program to control, in a case where an imaging region of the imaging unit acquiring the object where the object is detected moves, moving an imaging region of the adjacent imaging unit as well in a coordinated manner.

19. The control apparatus according to claim 1, wherein the one or more processors execute the program to control, in a case where a distance between the imaging unit acquiring the image in which the object is detected and the adjacent imaging unit is less than a threshold, superimposing an image indicating a direction toward the object as the image related to the object.

20. The control apparatus according to claim 1, wherein the one or more processors execute the program to control highlighting of one or both of the image in which the object is detected and the image of the adjacent imaging unit.

21. The control apparatus according to claim 1, wherein the plurality of imaging units are integrated into the control apparatus.

22. The control apparatus according to claim 1, wherein the plurality of imaging units are located external to the control apparatus.

23. The control apparatus according to claim 1, wherein the plurality of imaging units is configured to independently change their respective pan angles on the same circumference.

24. A method of a control apparatus, the method comprising:
acquiring a detection result of an object detected from images acquired by a plurality of respective imaging units configured to move independently on a same circumference;
controlling display of an image in which the object is detected and an image of an imaging unit adjacent to the imaging unit acquiring the image in which the object is detected on a display unit; and
controlling superimposing an image related to the object on the image of the adjacent imaging unit.

25. A non-transitory computer readable storage medium storing a program for causing a computer to perform a method of a control apparatus, the method comprising:
acquiring a detection result of an object detected from images acquired by a plurality of respective imaging units configured to move independently on a same circumference;
controlling display of an image in which the object is detected and an image of an imaging unit adjacent to the imaging unit acquiring the image in which the object is detected on a display unit; and
superimposing an image related to the object on the image of the adjacent imaging unit.
